(19) United States
(12) Patent Application Publication
(10) Pub. No.: US 2006/0198504 A1
(43) Pub. Date: Sep. 7, 2006

(54) Call recording platform

(76) Inventors: Yousef O. Shemisa, Half Moon Bay, CA (US); Kate Haley Shemisa, Half Moon Bay, CA (US); Mihai Codrean, Arad (RO)

Correspondence Address: GLENN PATENT GROUP, 3475 EDISON WAY, SUITE L, MENLO PARK, CA, 94025, US

(21) Appl. No.: 11/336,048

(22) Filed: Jan. 20, 2006

Related U.S. Application Data
(60) Provisional application No. 60/646,002, filed on Jan. 21, 2005.

(51) Int. Cl. H04M 3/42

(52) U.S. Cl. 379/201.02; 379/216.01; 370/352; 709/206

(57) ABSTRACT

The invention provides a digital voice recording platform that is used for live monitoring of calls, voice logging, incident reconstruction, compliance and liability reduction. The call recording platform is a fully fault tolerant system comprised of industrial grade single board (blade) computers. The call recording platform is provided for digital voice recording, supporting both digital and analog interfaces, all major proprietary PBX systems and providing support for VoIP. The platform makes intelligent use of call triggers, automatically responding to line signaling events to capture all of the associated call data. The platform provides access to a customizable variety of call recording options and modalities, a fast and effective search, and full archiving capabilities and management. At any time, a user can annotate or email a call, create custom search fields, track a case or customer, or burn an archive of recorded calls. As a LAN/WAN based server system, the platform provides seamless call data access from any networked client workstation.

### TECHNICAL FIELD

The invention relates to telecommunications. More particularly, the invention relates to a digital call recording and communications monitoring system.

### DESCRIPTION OF THE PRIOR ART

While voice messaging systems have progressed from simple home recorders to sophisticated, central voice mail systems, such systems are still relatively primitive with regard features offered in a call recording environment, for example for an enterprise. It would be advantageous to provide a call recording platform that provided robust features for a modern enterprise.

### SUMMARY OF THE INVENTION

The invention provides a digital voice recording platform that is used for live monitoring of calls, voice logging, incident reconstruction, compliance, and liability reduction. The call recording platform is a fully fault tolerant system comprised of industrial grade single board (blade) computers, communications monitoring hardware interfaces and call recording software. The call recording platform is provided for digital voice recording, supporting both digital and analog interfaces, all major proprietary PBX systems, and providing support for VoIP.

The platform makes intelligent use of call triggers, automatically responding to line signaling events to capture all of the associated call data. The presently preferred embodiment runs as a Windows Service, without requiring user intervention to begin call logging and recording. The invention also provides full archive management and an intelligent GUI.

The platform provides access to a customizable variety of call recording options and modalities, a fast and effective search, and full archiving capabilities and management. At any time, a user can annotate or email a call, create custom search fields, track a case or customer, or burn an archive of recorded calls. As a LAN/WAN based server system, the platform provides seamless call data access from any networked client workstation, locally or remotely.

The presently preferred embodiment of the invention provides a consistent user interface for all connection types including analog telephone, radio, digital PBX, digital trunk (E1/T1), intercom, turret, and video. The invention also provides support for encrypted and non-encrypted, commonly referred to as red and black, communications logging and monitoring in discrete servers, distributed systems or in a single mobile or stationary call recording server. A unique multi-play review allows a user to select up to eight recordings for simultaneous playback over a single connection. True client-server database operation, including remote database access, provides user level security controls, storage and optional clustering functionality for maximum reliability, expandability, and availability. Variable speed playback empowers transcription tasks and saves time in review. System monitoring is available anywhere with pager and email alerts. Review and email any desired portion of any recording is provided. The user can annotate any call in seconds. Hi-Z passive tapping is provided for minimal line loading. Voice compression is also performed in real-time, providing an extremely high storage density of 5.6 MB per channel-hour of recording, with no additional CPU loading. Call recording runs as a system service, without requiring user log in. A live monitor feature allows secure monitoring of channel input audio in the background, while recording to disk. Further, TCP/IP based networking (LAN/WAN) allows search/playback on remote systems.

### BRIEF DESCRIPTION OF THE DRAWINGS

FIG. 1 is a screen shot showing a viewer according to the invention;

FIG. 2 is a screen shot showing a select server tab according to the invention;

FIG. 3 is a screen shot showing a select server menu according to the invention;

FIG. 4 is a screen shot showing a log on to a selected server screen according to the invention;

FIG. 5 is a screen shot showing quick search options according to the invention;

FIG. 6 is a screen shot showing expert search options according to the invention;

FIG. 7 is a screen shot showing a search results grid according to the invention;

FIG. 8 is a screen shot showing call playback according to the invention;

FIG. 9 is a screen shot showing multi play calls according to the invention;

FIG. 10 is a screen shot showing an audio editor according to the invention;

FIG. 11 is a screen shot showing a call detail record according to the invention;

FIG. 12 is a screen shot showing annotation detail view according to the invention;

FIG. 13 is a screen shot showing an annotation detail record according to the invention;

FIG. 14 is a screen shot showing live monitoring according to the invention;

FIG. 15 is a screen shot showing live call commenting according to the invention;

FIG. 16 is a screen shot showing a sample report from a reporting menu according to the invention;

FIG. 17 is a screen shot showing management of recording schedules according to the invention;

FIG. 18 is a screen shot showing editing of recording schedules according to the invention;

FIG. 19 is a screen shot showing editing of recording schedule assignments to channels according to the invention;

FIG. 20 is a screen shot showing creating of a new system user according to the invention;

FIG. 21 is a screen shot showing assigning user rights according to the invention;

FIG. 22 is a screen shot showing assigning users to groups according to the invention;

FIG. 23 is a screen shot showing a managing groups main view according to the invention;

FIG. 24 is a screen shot showing assigning group properties and members according to the invention;

FIG. 25 is a screen shot showing edit channel assignment—assigning users to channels according to the invention;

FIG. 26 is a screen shot showing a contextual online help menu according to the invention;

FIG. 27 is a block schematic diagram showing a distributed call recording platform according to the invention;

FIG. 28 is a screen shot showing display of metadata that accompanies a call according to the invention;

FIG. 29 is a screen shot showing a simple query in a viewer according to the invention;

FIG. 30 is a screen shot showing an example of a results list of call records according to the invention;

FIG. 31 is a screen shot showing selection of recording formats according to the invention;

FIG. 32 is a screen shot showing live monitoring of multiple agents and extensions according to the invention;

FIG. 33 is a screen shot showing a detail of live monitoring of agents and extensions according to the invention;

FIG. 34 is a screen shot showing a filtered raw log according to the invention;

FIG. 35 is a screen shot showing the processed output of a typical logging session ready for template creation;

FIG. 36 is a block diagram of the call recording platform comprising the invention, showing the primary system components;

FIG. 37 is a block diagram showing the components of the server core and the flow of informational messages between the primary system components;

FIG. 38 is a block diagram showing the flow of live audio from a tapped line to the viewer client application.

### DETAILED DESCRIPTION OF THE INVENTION

The invention comprises a call recording platform for enterprise-wide quality monitoring and call recording. The invention provides access to a customizable variety of call recording options and modalities, a fast and effective search, and full archiving capabilities and management. At any time, a user can annotate, flag, or email a call, simultaneously record and playback calls, perform live monitoring for quality assurance, or burn an archive of recorded calls. As a LAN/WAN based server system, the invention provides seamless call data access from any networked client workstation.

The presently preferred embodiment of the invention comprises a call recording platform that has three main parts: a viewer; a commander; and a server core.

Viewer

The viewer comprises an intuitive graphical user interface (GUI) for agents and supervisors. It provides the needed user controls in a single application. The viewer provides a local or remote TCP/IP interface for business rules and user administration, call data retrieval and search, record annotation, playback, monitoring, and transcription of calls.

Commander

The commander is the GUI for the administrator's use. The commander interface allows the systems administrator to configure the recording server. The commander features full catalog data management controls and allows for administration of the server core server preferences (settings).

Server Core

The server core provides the interface to the IP network and telephony/radio hardware interfaces, while enabling call data logging to the database manager. This component runs as a Windows Service and therefore runs as a background process without requiring user intervention to begin call recording and logging. The server core monitors and handles DVD recording and online volume data, as well as managing archived catalogs in the database and handling archive creation (DVD burning).

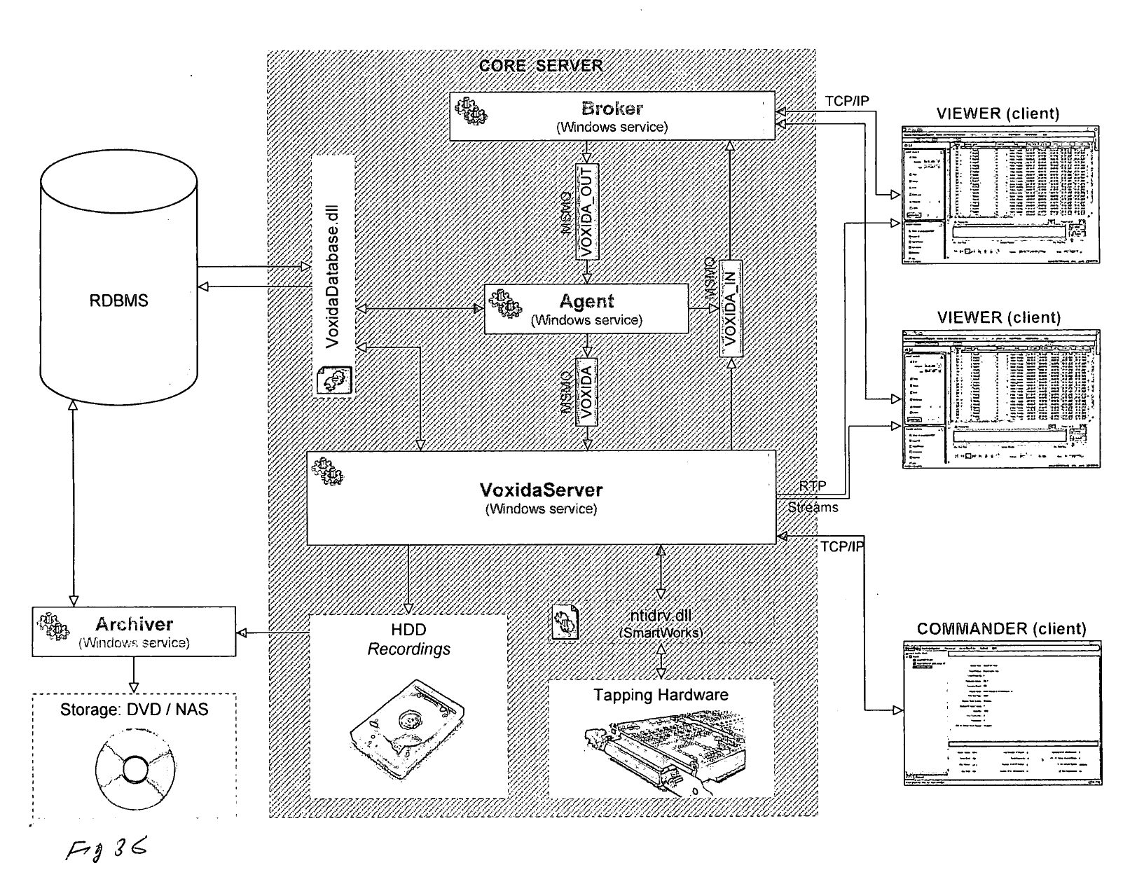

FIG. 36 is a block diagram of the call recording platform comprising the invention.

User Roles

The invention deploys a user scheme, much like Windows 2000 or 2003. Users are assigned a role that is governed by a list of rules that permit the user to perform certain tasks and access information. Each user is assigned a role by the user having the administrator role.

The primary roles are:
Basic User
Supervisor
Manager
Archive Operator
Administrator
   Groups

Users are assigned to groups.

A group is a set of users. According to the user role status and the permissions that it allows, a user may be able to live monitor, record, comment, or search, review and playback calls that are received by the user's group.

Supervisors can monitor, record, and review all the calls received by all basic users in their group.

Managers can monitor record and review calls received by basic users, center-wide, irrespective of their group membership.

For example, if you are a supervisor and have five basic users assigned to your group, you can monitor those basic users. If you are a supervisor of more than one group, you can monitor all the basic users in each of the groups that you are assigned to. If you are a manager, you can monitor all groups of all basic users. As a manager, you do not need to be assigned to a group to monitor it.

Basic User

When the administrator creates a new user, that user is assigned an inactive, basic user role by default. A basic user can log on to the platform, but must be assigned a channel before they can search, review, monitor, or record any calls. This means that a basic user only becomes active once they are assigned to one or more channels. Most of the users in the call center are assigned an active basic user role.

Agent

Agent only applies if the associated center is using dynamic seating or an agent log-in system. Dynamic seating/agent log-in support allows the mapping of agents to variable extensions by capturing the agent log on via DTMF touch tones or d-channel messenger sent from the PBX to the Agent's station. This is often used to integrate the call recording platform with larger communication systems. If you are not using this package, Agent is not relevant and does not appear in the user interface.

Supervisor

The supervisor role is allowed the same recording and review tools of a basic user. The supervisor also has permissions to monitor other assigned basic user groups in the call center. The supervisor, like the basic user, accomplishes all of their tasks using the viewer.

The supervisor can also perform the following tasks:
Live monitor basic user calls in progress for quality assurance
Create and edit recording schedules; and
Review, edit, export and email calls from all basic users in their charge.
   Manager

Some contact centers will also assign a manager role. The manager is has all the permissions and responsibilities that the supervisor has. The manager is allowed to listen and access all call data from all basic users in all groups.

In short, the manager also does the following monitoring, recording, and review tasks:
Monitoring calls in progress (Live Monitoring) all groups of channels and basic users;
Creating and editing recording schedules; and
Reviewing, editing, exporting and emailing calls, center-wide.

The manager, like the supervisor and basic user, accomplishes all of their tasks using the viewer.

Archive Operator

The archive operator role is in charge the administrator's duties surrounding archiving.

Archive operator tasks include:
Physically loading removable media into the platform's optical drive;
Manual archiving; and
Media catalog management.
   Administrator

The administrator is platform's super user. The administrator is a member of the Windows 2000 administrator's group and is responsible for:
Configuration and administration of all roles;
Powering on and off the unit;
Setting auto archive rules;
Channel configuration;
Hardware specific settings; and
Setting and receiving system alarm notification.
   Interfacing with the Server Core

The server core provides the interface to the IP network and telephony/radio hardware interfaces, while enabling call data logging to the database manager. This component runs as a Windows Service and therefore runs as a background process without requiring user intervention to begin call recording and logging. The server core monitors and handles DVD recording and online volume data, as well as managing archived catalogs in the database and handling archive creation (DVD burning). The server core is the server, the receptacle of site and regional specific settings and default behaviors ensuring that no data are lost and that the platform functions properly without user intervention.

The server core consists of the following modules:
Agent Service
Broker Service
Database Driver
Server Service
   MSMQ Interface and Message Queues.

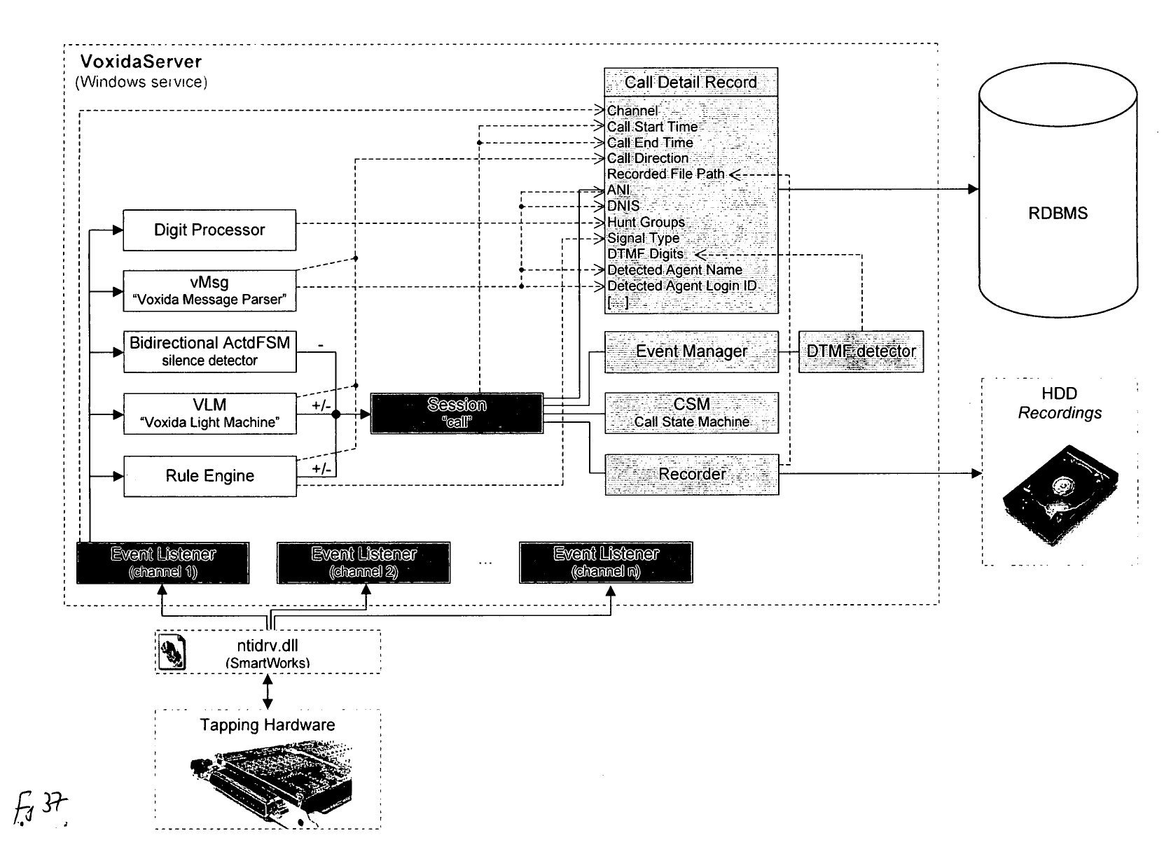

FIG. 37 is a block diagram showing the components of the server core and its interfaces

User Interface (UI) Session

The following discussion describes the call recording platform viewer UI as a session, showing facilities of the system.

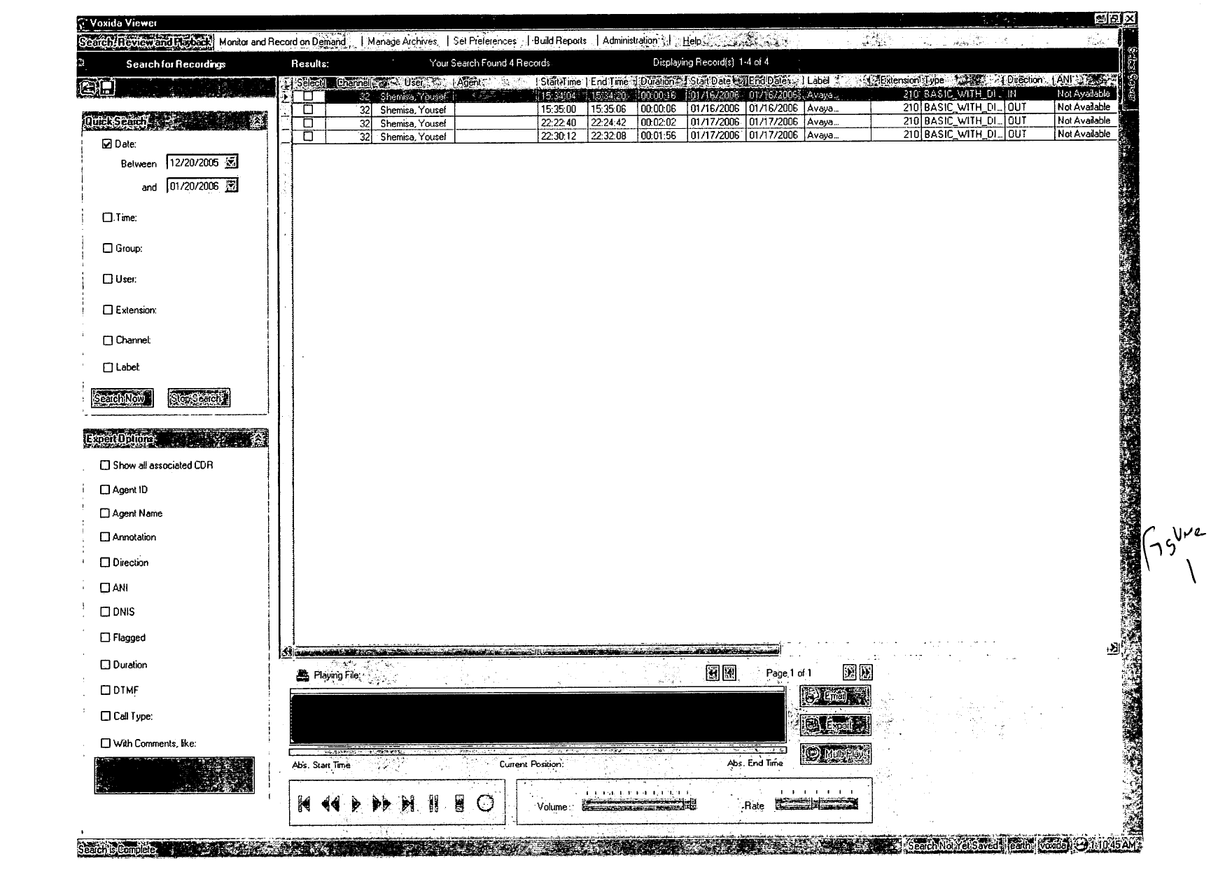

Basic users can become proficient on the system in two hours. The screens shots above show the UI of the viewer. When one starts to work with the viewer, there is a window with several tabs spanning the top. These tabs group related tasks together so that one can conveniently and quickly capture, monitor, retrieve, and review vital data. FIG. 1 is a screen shot showing a viewer according to the invention.

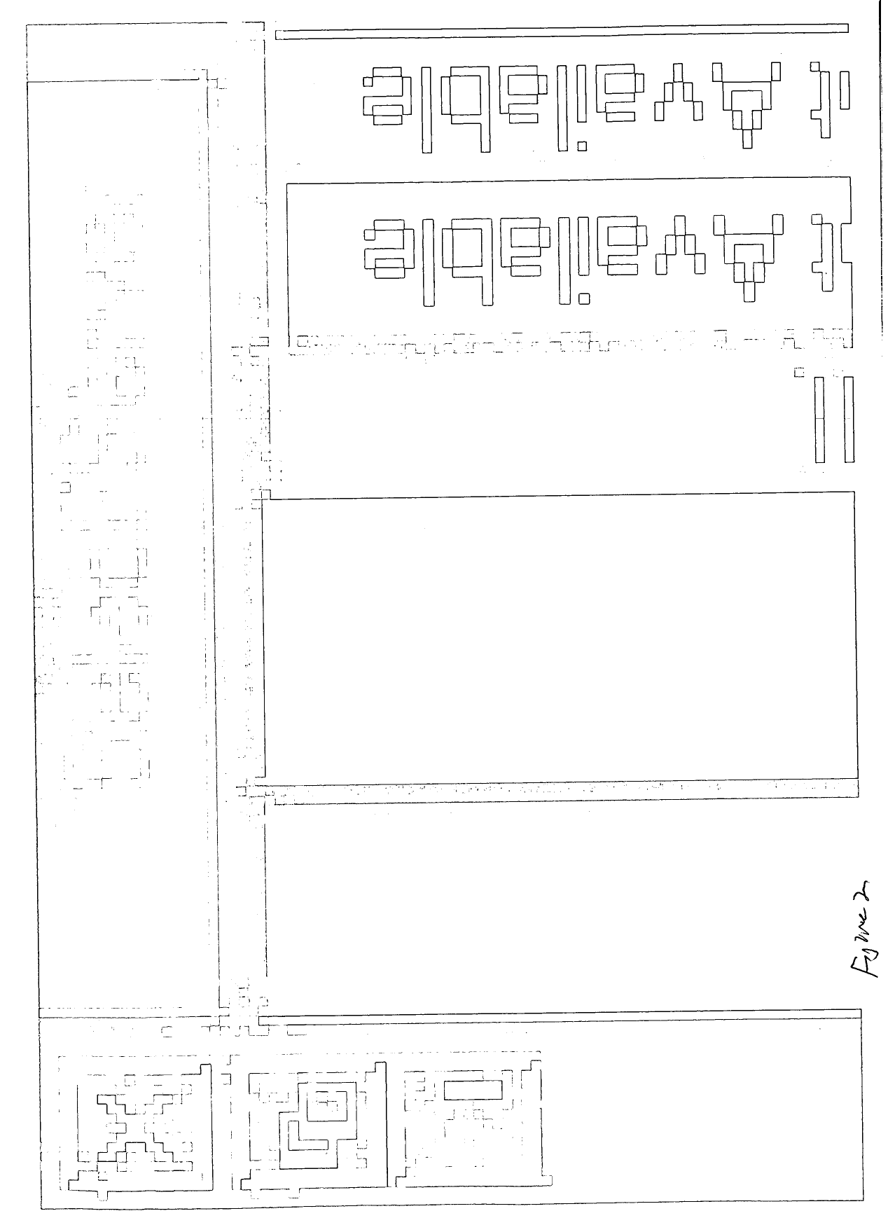

Before one can start using the viewer, one must select and log onto a server. First access and expand the select server menu by single-clicking on the orange select server tab on the right side of the viewer. FIG. 2 is a screen shot showing a select server tab according to the invention.

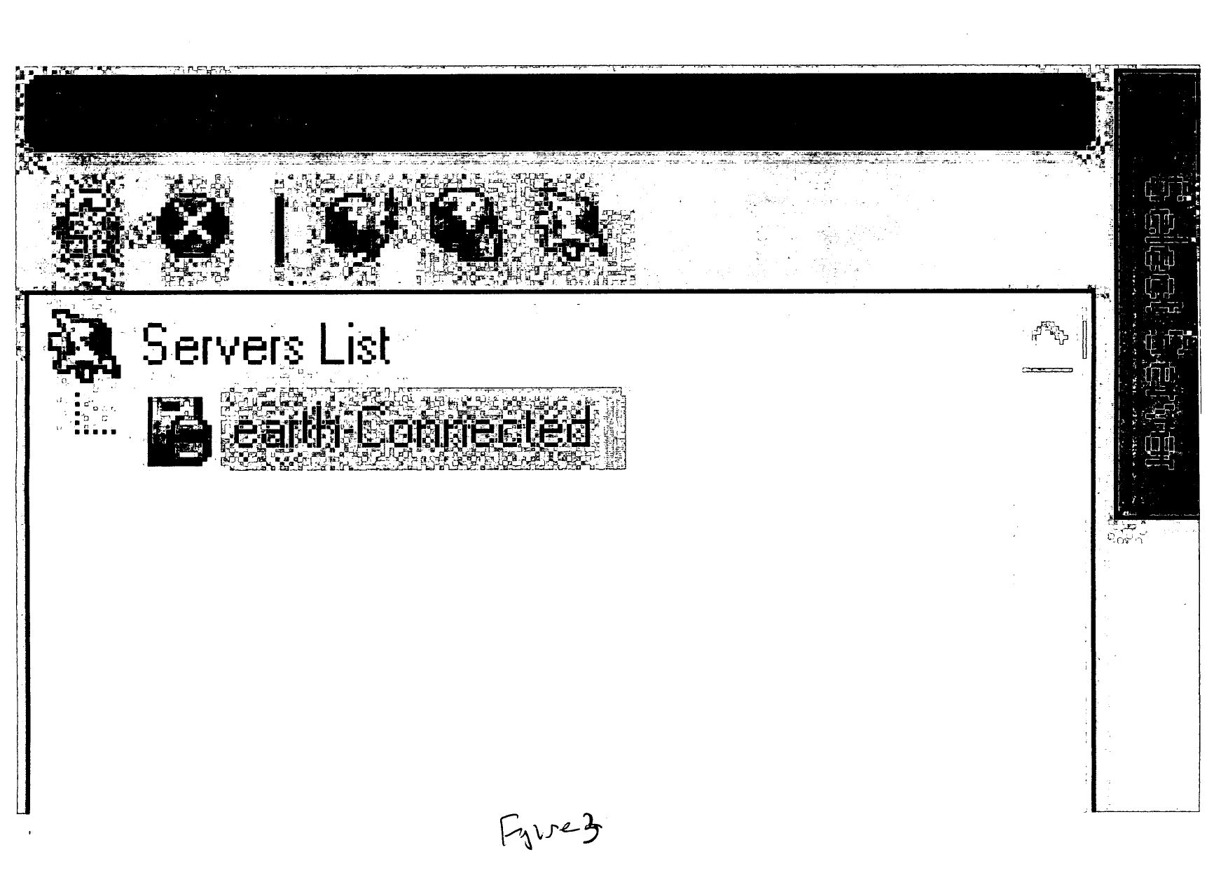

Once the select server menu is expanded, one sees a list of servers on the network. FIG. 3 is a screen shot showing a select server menu according to the invention.

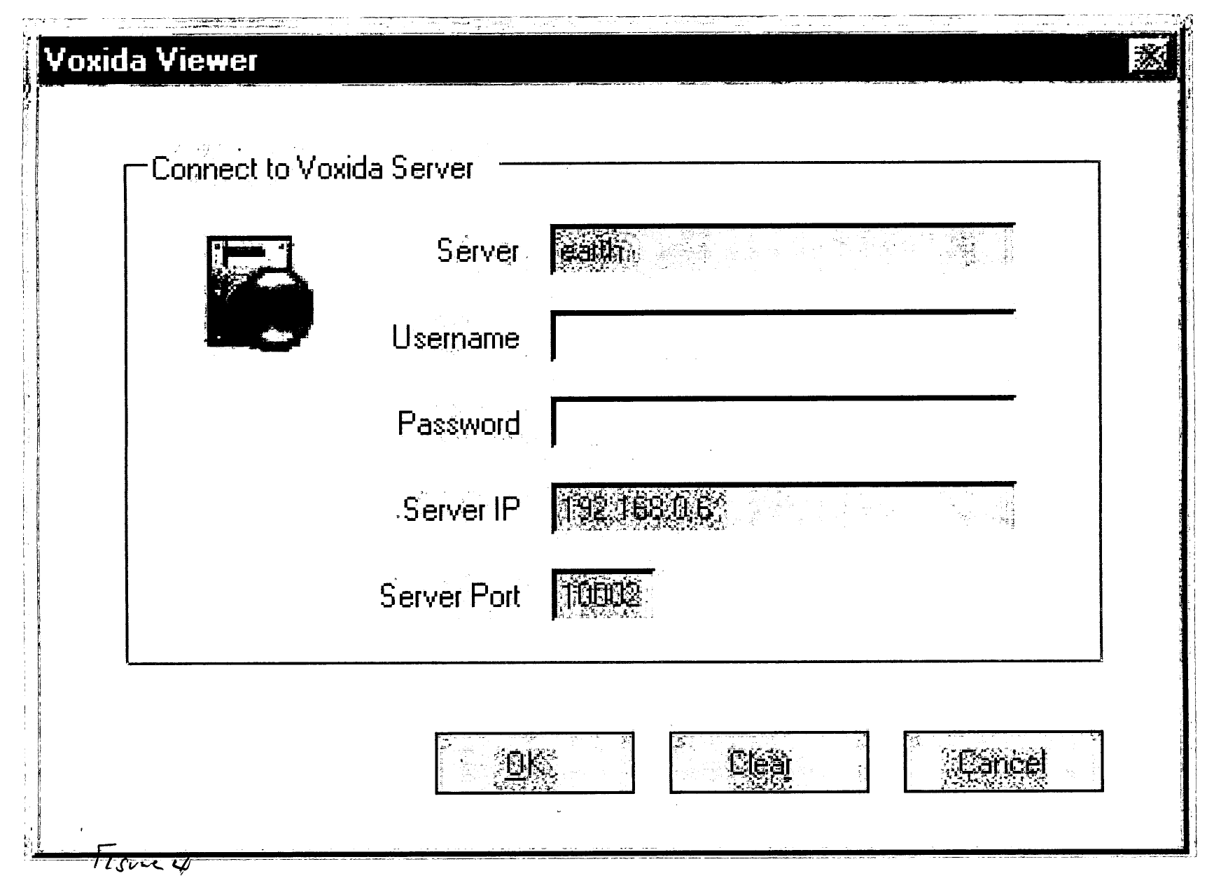

Single-click on a server to select it. Click the connect to selected server icon above. The user is prompted to log on. FIG. 4 is a screen shot showing a log on to a selected server screen according to the invention.

Once one has successfully logged on the server, the viewer appears with the search, review, and playback tab opened. Take note of the tabs the top of the window. They are used to open windows that house like tasks.

The tabs are:
Search, Review, and Playback
Monitor and Record on Demand
Manage Archives
Set Preferences
Build Reports
Administration
Help

Most users have several of the tabs inactive. Upon logging in a user profile and user role is communicated to the viewer. The viewer only shows the tabs that are available to the user's user group. Basic users work with the search, review, and playback tab. After the user has recorded calls, he is able to search, review, playback, annotate, flag, export, and email the call records. The call records that the user has access to varies by user role status and group membership.

Searching and Reviewing Calls

One of the invention's most notable features is its ability to allow a user to search for recorded calls conveniently, and with the level of granularity that is desired. One can search for calls to review and playback any time that one has the search, review and playback tabbed interface open.

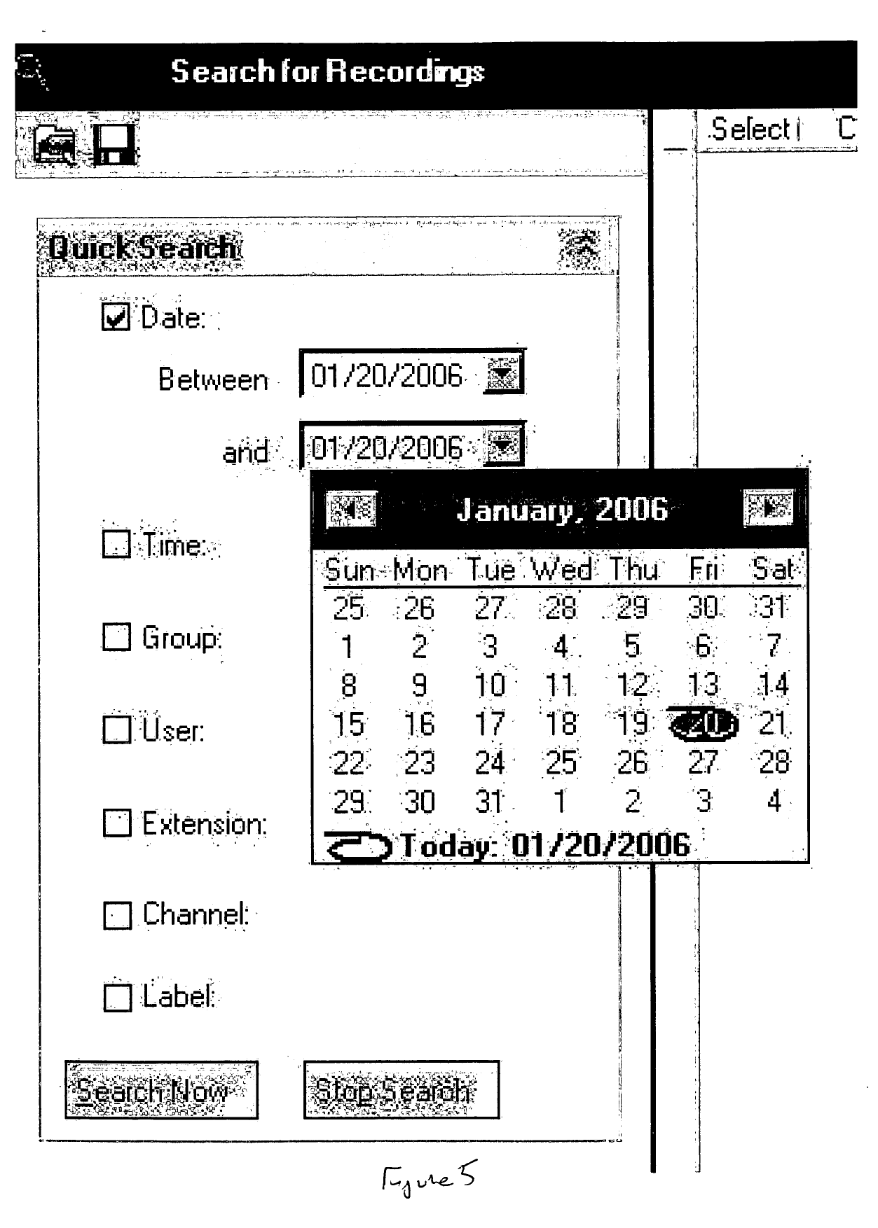

FIG. 5 is a screen shot showing quick search options according to the invention. When one wants to search for call records, the search options at the left of the screen are used. The items that one can search by are grouped into a quick search menu and an expert search menu.

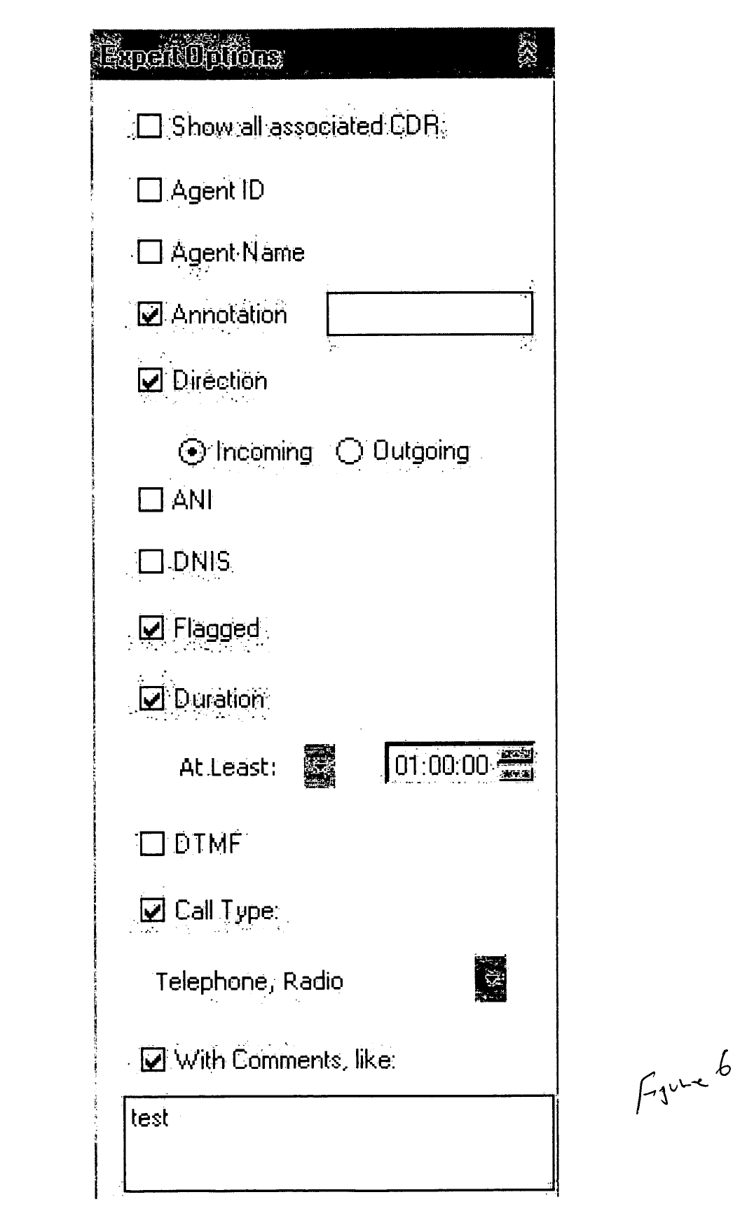

Expert search allows a user to query the database for records that fit a more detailed criteria than that available on quick search. Expert search options are used in addition to the quick search. To expand the expert options, click the expert search menu bar below the quick search. FIG. 6 is a screen shot showing expert search options according to the invention.

In expert search, one can search by:
Agent ID and Agent Name
Direction—Whether the call is incoming or outgoing
ANI—Automatic number identification—the calling number
DNIS—Dialed Number Identification Service—the called number or DID number from the PSTN Central Office or PBX Switch.
Flagged—If the call record has been flagged for review
Duration—Specify at least, at most, or in between time durations
DTMF—Dual Tone Multi Frequency, or tone dialing
With Comments—Search by call record annotations by keyword

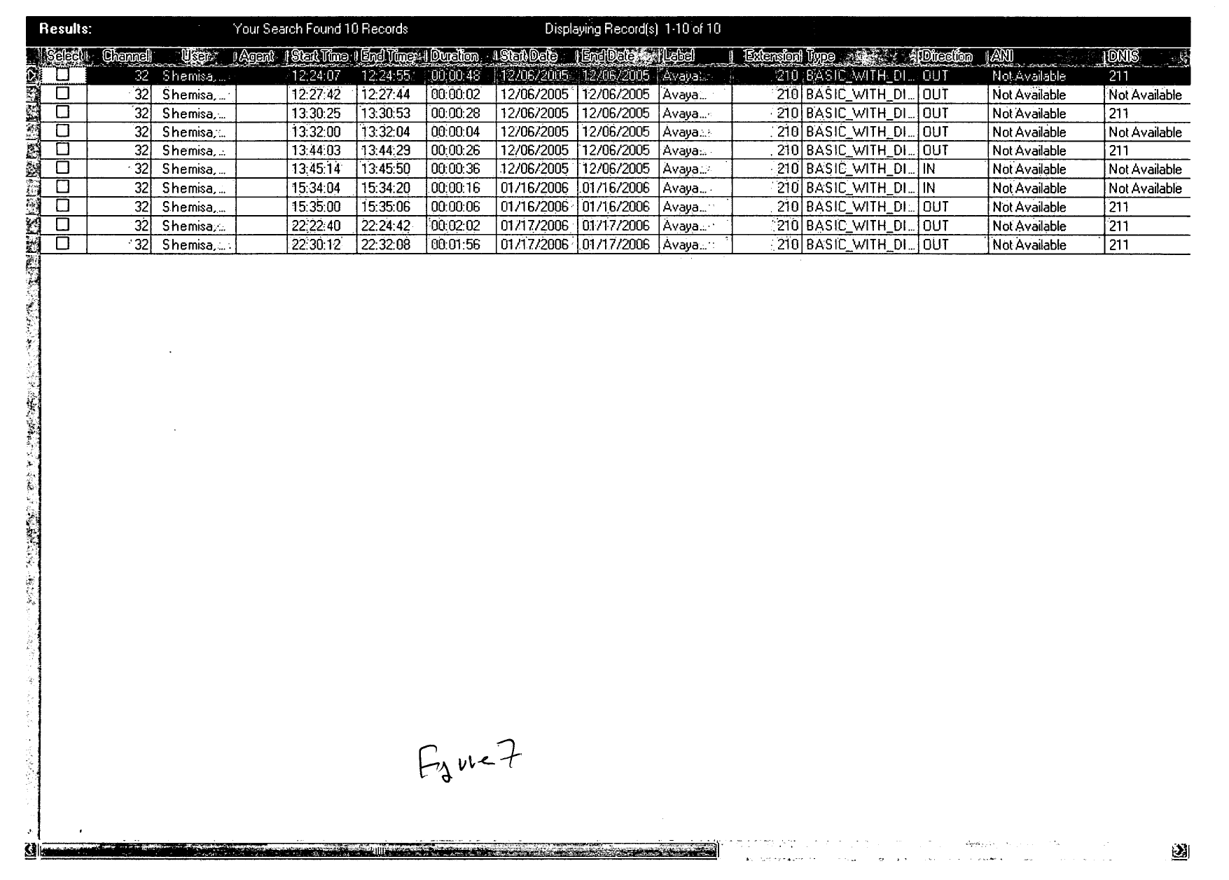

The viewer returns all call records that match search criteria. The call records are returned in the results grid at the top right side of the screen. The results grid is designed to give the user the vital data about a call, at-a-glance. Additional call details can be viewed for all returned records by moving the bottom scroll bar to the right or by double-clicking a record to open the call detail view. The top of the results grid tells how many records were returned. There is also information about how many pages of results were returned and what page the user is currently on. In the event that the user queries returned multiple pages of the call records as results, the user can page through records using the arrow buttons directly below the bottom scroll bar. FIG. 7 is a screen shot showing a search results grid according to the invention.

The results provide the following information:
Agent ID and Agent Name
   Basic User—This lists the basic user's last and first name
Group—This shows what group or groups the basic user is assigned to
Start Time—The call's start time
End Time—The call's end time
Start Date—The day the call started
End Date—The day the call ended
Extension—The extension that the call recorded on
ANI—Automatic number identification or caller id or calling line identifier
DNIS—Dialed number identification service
Direction—Call direction—incoming or outgoing call
Channel—The channel the call was on
Source—Specifies whether the call is still on the local server or if it has been archived to CD-R/DVD-R. In the case that the call has been archived, this field tells the user on what removable media volume to locate the call on
Flagged—This shows if the call has been flagged for supervisor review
   Playing Back a Call

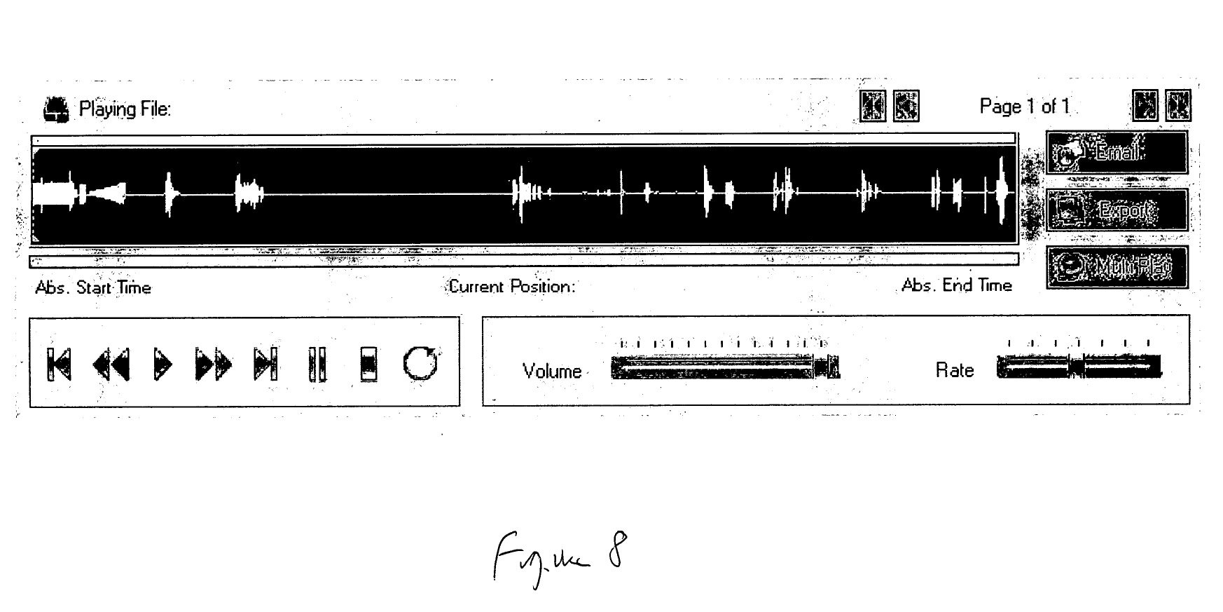

Once a record is selected, click the play button to load the call into the playback area of the screen. FIG. 8 is a screen shot showing call playback according to the invention.

The playback area displays a graphical representation of the call data and provides information about the selected record's start and end time. Upon clicking play, one can watch the playback progress in the current position field, as well as watching the graphical call data progress. If the play buttons are grayed out and only the multi play button is active, it means there are other records selected and the user must display the screens for the other records. Take note of the information provided at the top of the playback area. Here one can find the file name and can tell if the call is playing back from an archive or if the call is still being stored on the local machine. The icon to the right shows a DVD-R disk if the file is playing from an archived volume. If the record is playing from platform hard drives, a hard drive icon appears. Click the rate slider on different positions to change the rate. Double-click the slider to rest the rate to normal.

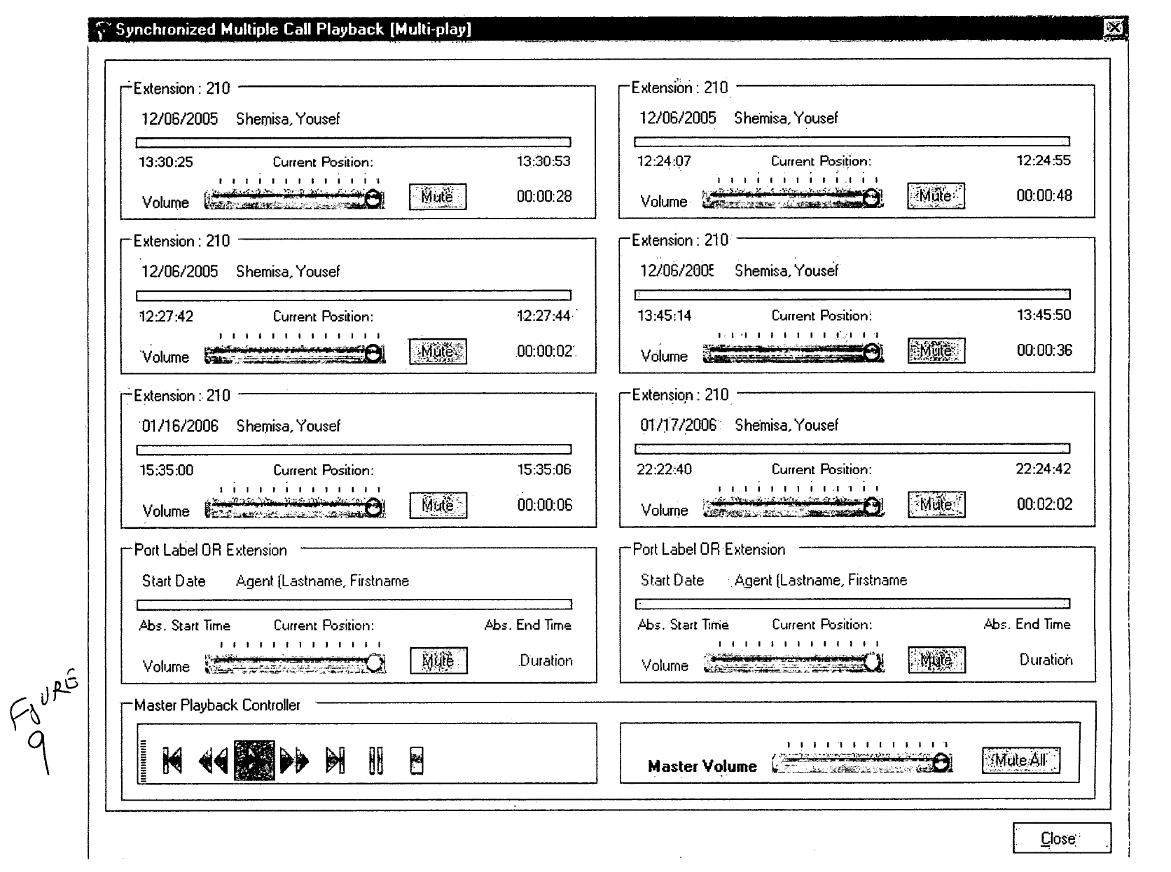

Multi play allows the user to play up to eight, synchronized call records at once. This is particularly helpful for incident reconstruction, high traffic radio call review and in busy dispatch environments. To use multi play, select two to eight calls from the search results grid. Click the multi play button. The synchronized multiple call playback window launches and the user can initiate the playback of the calls here. FIG. 9 is a screen shot showing multi play calls according to the invention.

The synchronized multiple call playback window lists the following vital information about each call:
Channel Label or Extension
Start Date
User Name
Duration
Each call has a progress bar and indicates absolute start time, absolute end time, and the progress of the call playback
Each call record has its own Volume Slider and a Mute button

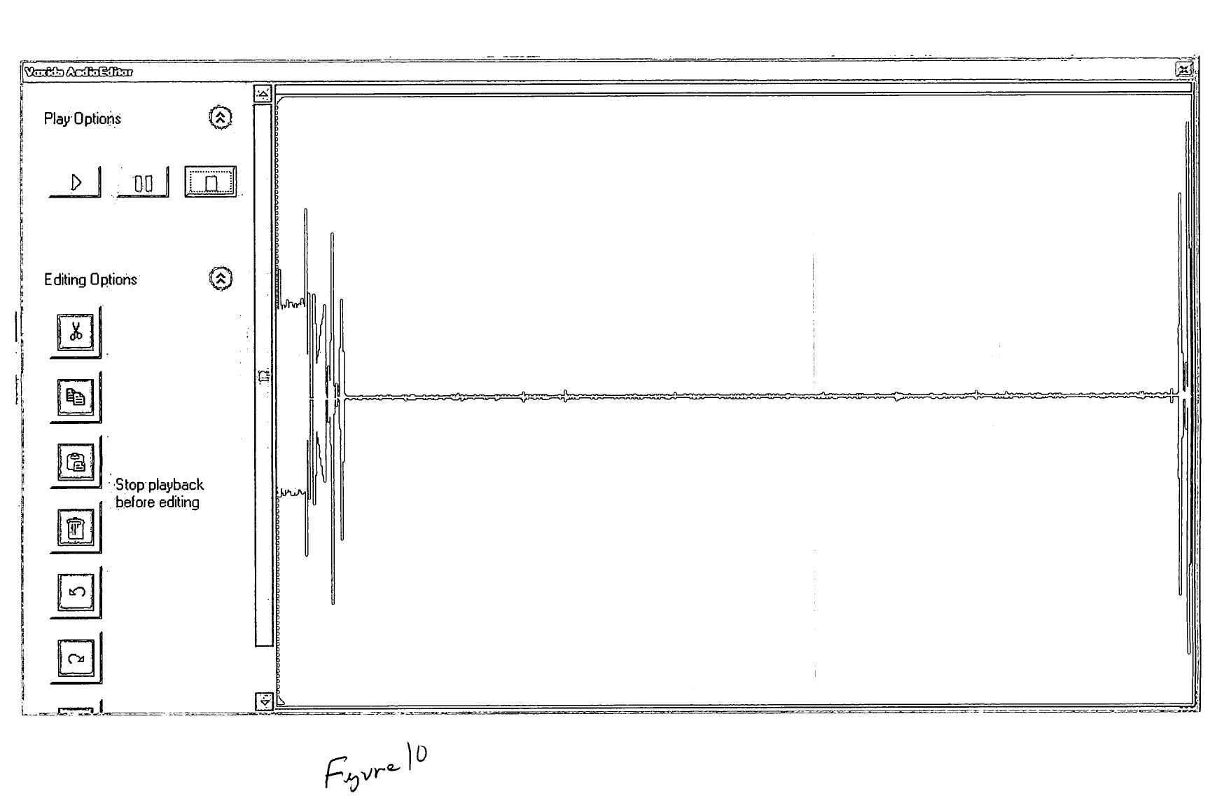

When the user has selected a call for playback and loaded it into the playback area by clicking the play button, the user can access the audio editor to edit the call. To open the audio editor, the user navigates his mouse to the wav displayed in the playback region of the search, review, and playback window. Double-click the wav form. FIG. 10 is a screen shot showing an audio editor according to the invention. The audio editor works on a copy of the call. One can edit here and email or export the call as a standard wav file.

When in the audio editor, the user can use the standard call editing tools, provided on the left menu. To select portions of the call for playback or editing, the user left-clicks and drags his mouse over the wav form. Release the mouse button when the desired area is selected. Take note of the playback buttons that allow the user to review the call conveniently in the editor. When the user is editing the call, a copy of the call is saved to the local directory. For security reasons, the original call record is not modified. All the changes that the user makes and saves are reflected in the copy of the call.

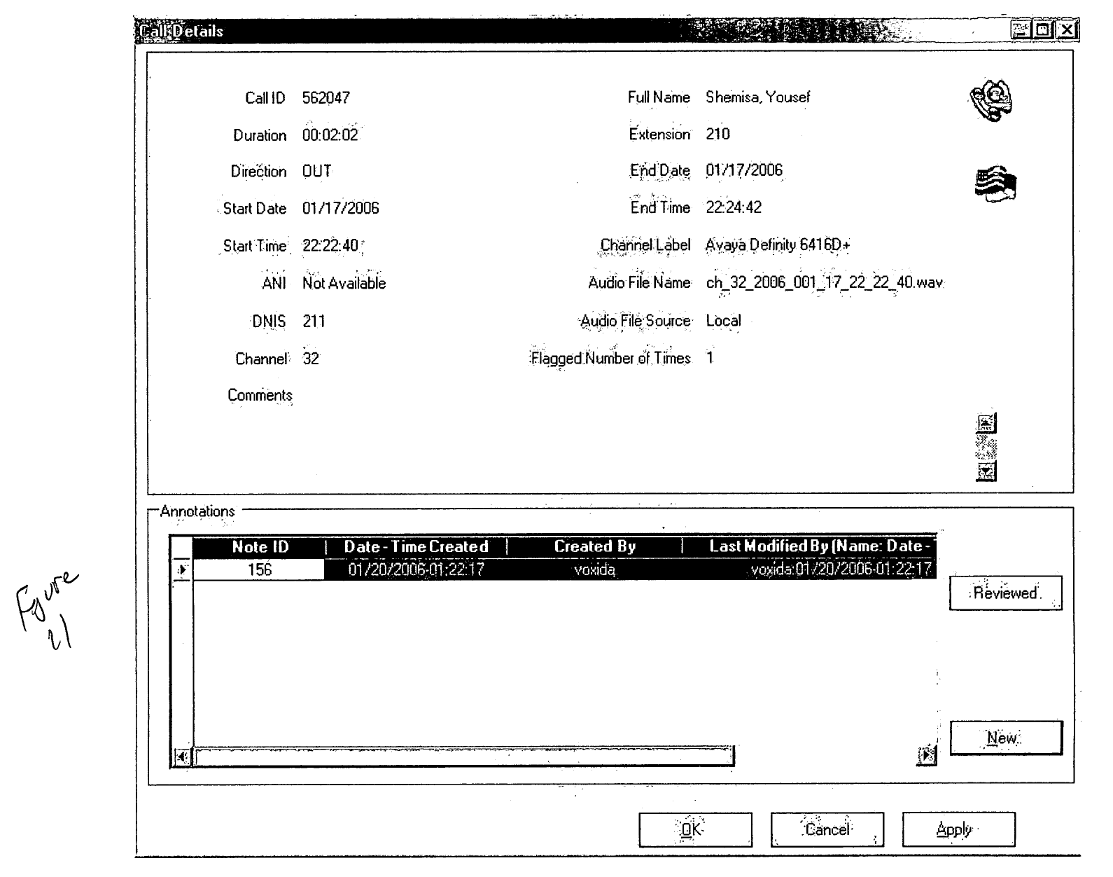

Once the user has reviewed the search results in the results grid, the user may wish to see more details about a call and annotate, read comments, or flag the record. The call detail view provides all the call data and fields for augmenting your call record data. FIG. 11 is a screen shot showing a call detail record according to the invention.

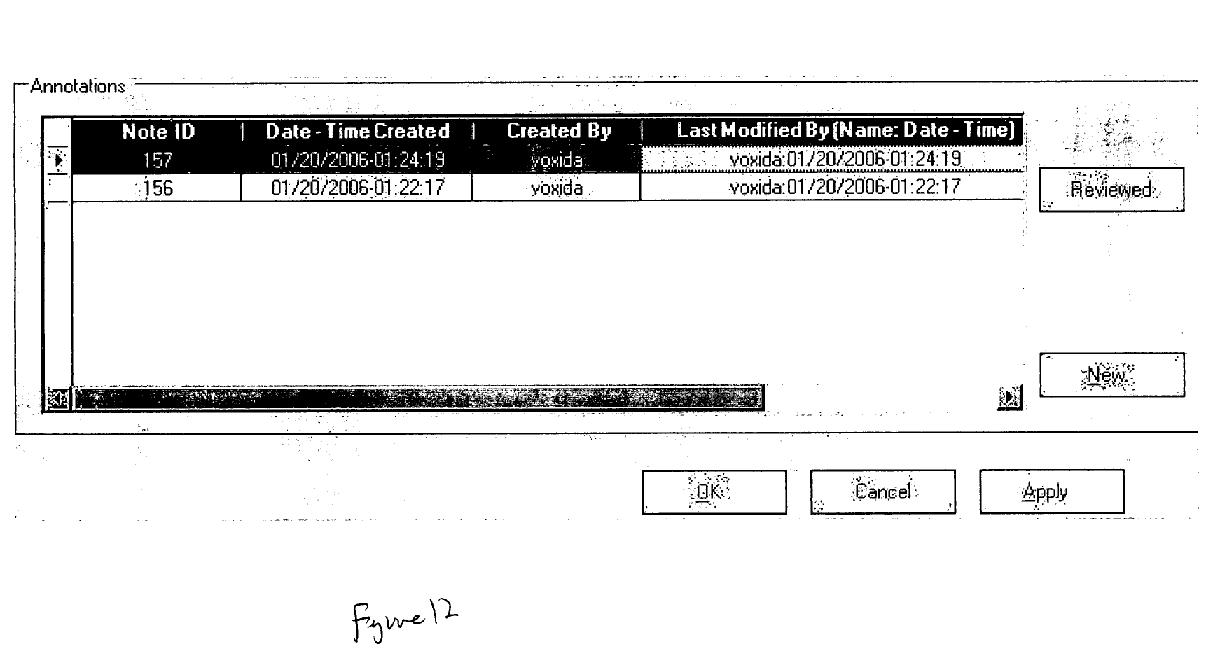

The call detail view has many of the fields that are in the viewer search, review, and playback main results grid (detailed above). Additionally, the call detail view displays a comment field and return a list of all the annotations related to the call record. In the call detail view, there is a list of the annotations that have been saved with this call. The user can read the complete annotation details by double-clicking a one of the annotation records. This launches the annotation detail view. FIG. 12 is a screen shot showing annotation detail view according to the invention.

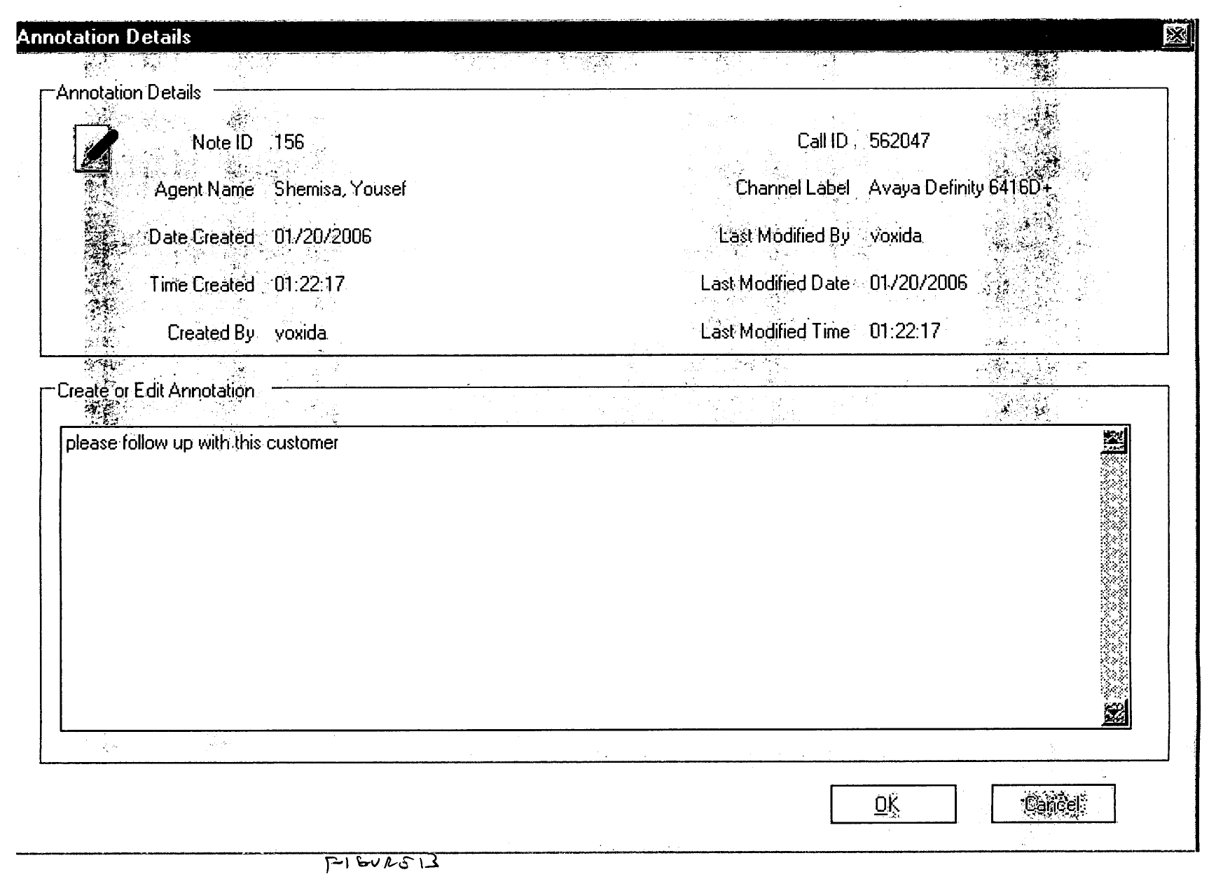

The annotation detail provides helpful information including who initially annotated the call, who last modified the annotation, with the time and date for each. The user also can read the complete annotation here. When the user is done reading the annotation, click OK to return to the call detail view. FIG. 13 is a screen shot showing an annotation detail record according to the invention.

If the user wishes to annotate the call, the call detail record allows him to do so. Simply click the New button to launch the annotation detail view where the user can write a note in the “Write or Edit Note Here” box. When the user is done leaving the note, click OK. This returns the user to the call detail view. Note the annotation record now appears in the call detail view.

Live Monitoring

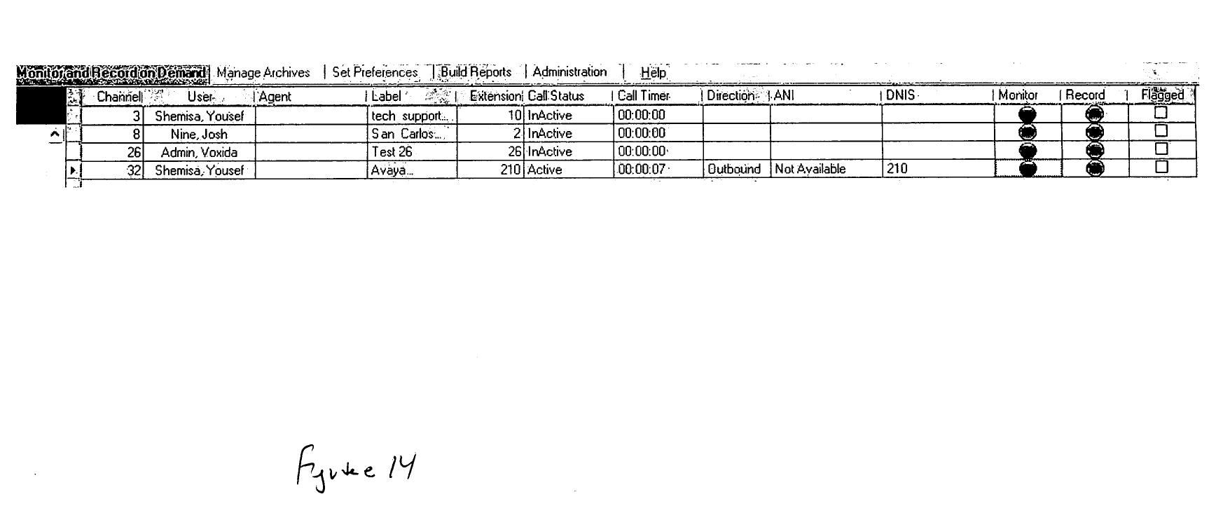

Monitoring is often referred to as live monitoring or quality monitoring. Monitoring is listening to a call that is in progress, whether or not it is currently being recorded. A basic user can live monitor their own calls while a supervisor or manager may live monitor basic users in their group for grading, quality assurance, and observation. The monitor and record on demand tab allows the user to view the basic users and channels that he can listen to and record. FIG. 14 is a screen shot showing live monitoring of multiple agents over the LAN/WAN according to the invention.

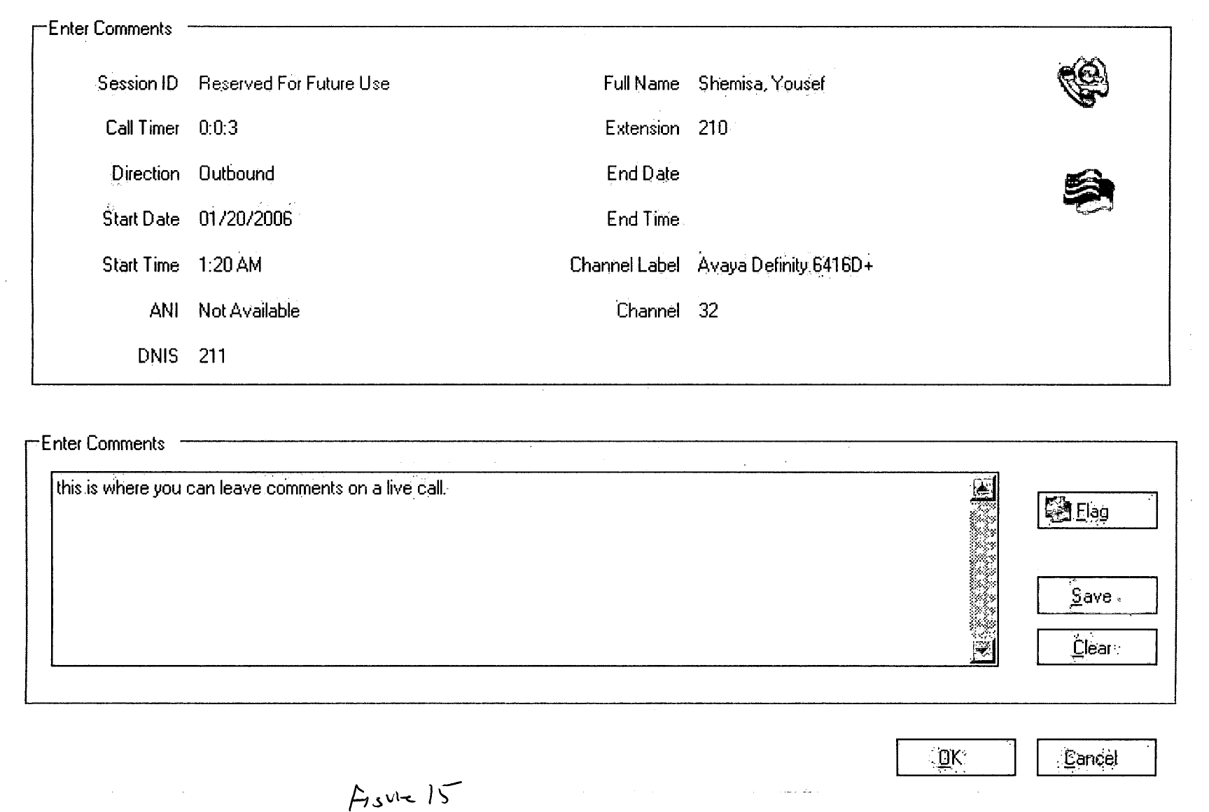

One of the platform's most useful features is the ability to comment a call quickly while the user is monitoring and recording the call. This allows for up to the minute vital call data to be shared across the network. To comment or flag the call, click the comment or flag call button. The real time call detail opens. FIG. 15 is a screen shot showing live call commenting according to the invention.

A comment is a quick note that is written while the call is in progress. One can comment live calls if one is recording full time or on demand, but can only leave a comment while monitoring the call. To comment a live call, in the monitor and record on demand main window, select a call and click the comment or flag call button. The real time call detail window opens. Click in the comments field and quickly add notes for future searching and reference. If the user wants to flag the call for review, the flag button is clicked. When the user is done commenting and flagging a call in the real time call detail window, click OK. The user is returned to the monitor and record on demand main interface.

Reporting

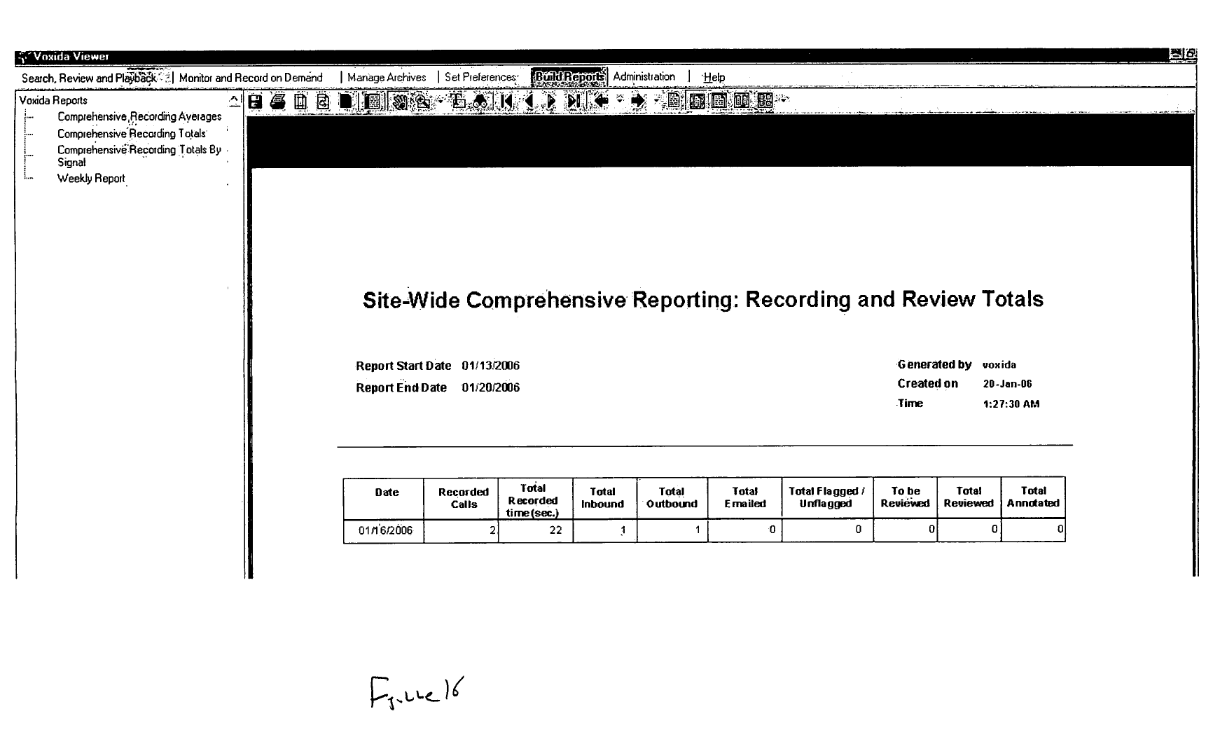

It is often helpful to run weekly (or other periodic) reports to get regular analytics for the call center. The user can do so by selecting weekly ranges and running reports. The weekly reports contain data about call volume in a given period. FIG. 16 is a screen shot showing a sample report from a reporting menu according to the invention.

Administration

The platform is designed to accommodate unique recording requirements. One of the ways that the platform works is to provide a powerful set of controls to create, edit, assign, and delete recording schedules. A recording schedule is a rule that tells the platform when to record on a given day. The recording schedule can be applied to one, many or to all days. The user has additional recording flexibility because he can assign more than one recording schedule to a day. This means that if the user needs to record two different time slots per day, he can easily and effectively do so.

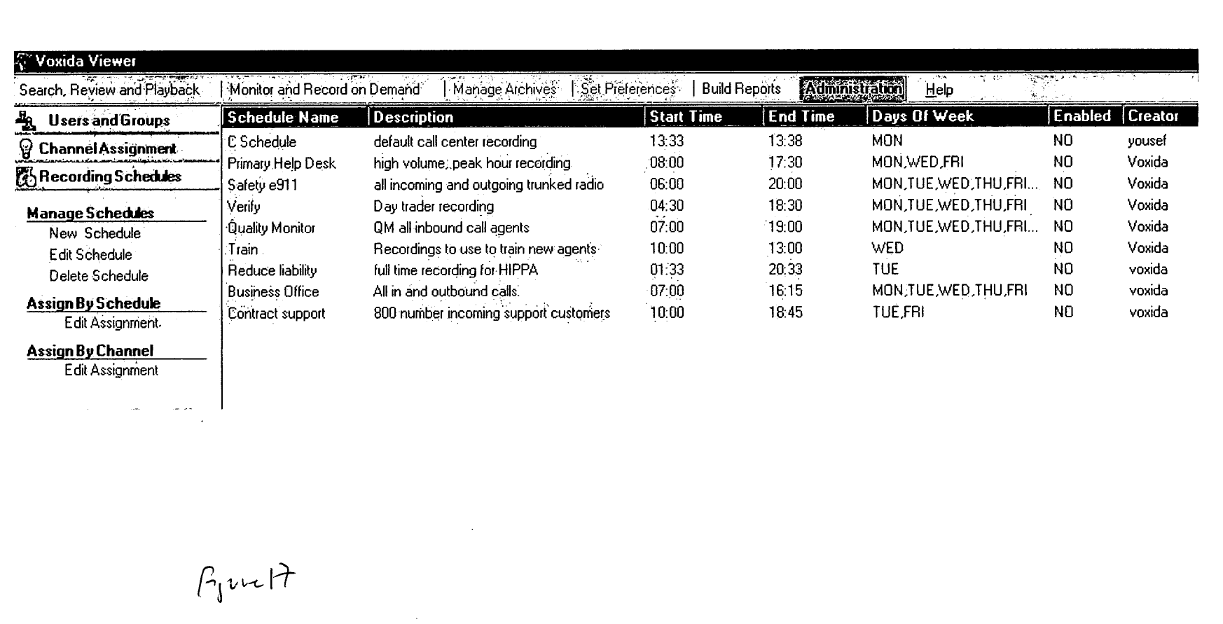

The following discussion describes how to create, edit, and delete a schedule. FIG. 17 is a screen shot showing management of recording schedules according to the invention. When the user clicks manage schedules, he sees the manage schedules summary view (FIG. 17). The user sees a list of schedules in rows in the summary view, which provide at-a-glance-data, the following:
Schedule Name
Description—A short descriptor for the schedule
Start Time—When to beginning recording
End time—When to stop recording
Days of Week—The days that the schedule is applied
Enabled—Whether or not the schedule is enabled
Creator—Who initially created the schedule

To create a new recording schedule, click new schedule menu option on the left menu. If new schedule is not viewable, expand the recording schedules menu by clicking on it. When the user clicks new schedule, the new schedule window opens. In new schedule, the user fills in schedule name, description, start time, end time, and clicks the days of week that the schedule is active on. After the user fills out the data and clicks create, the schedule appears in the manage schedules main view. Once the schedule is created, the user may assign it under the assign by schedule or assign by channel menu options on the main screen's left navigation bar.

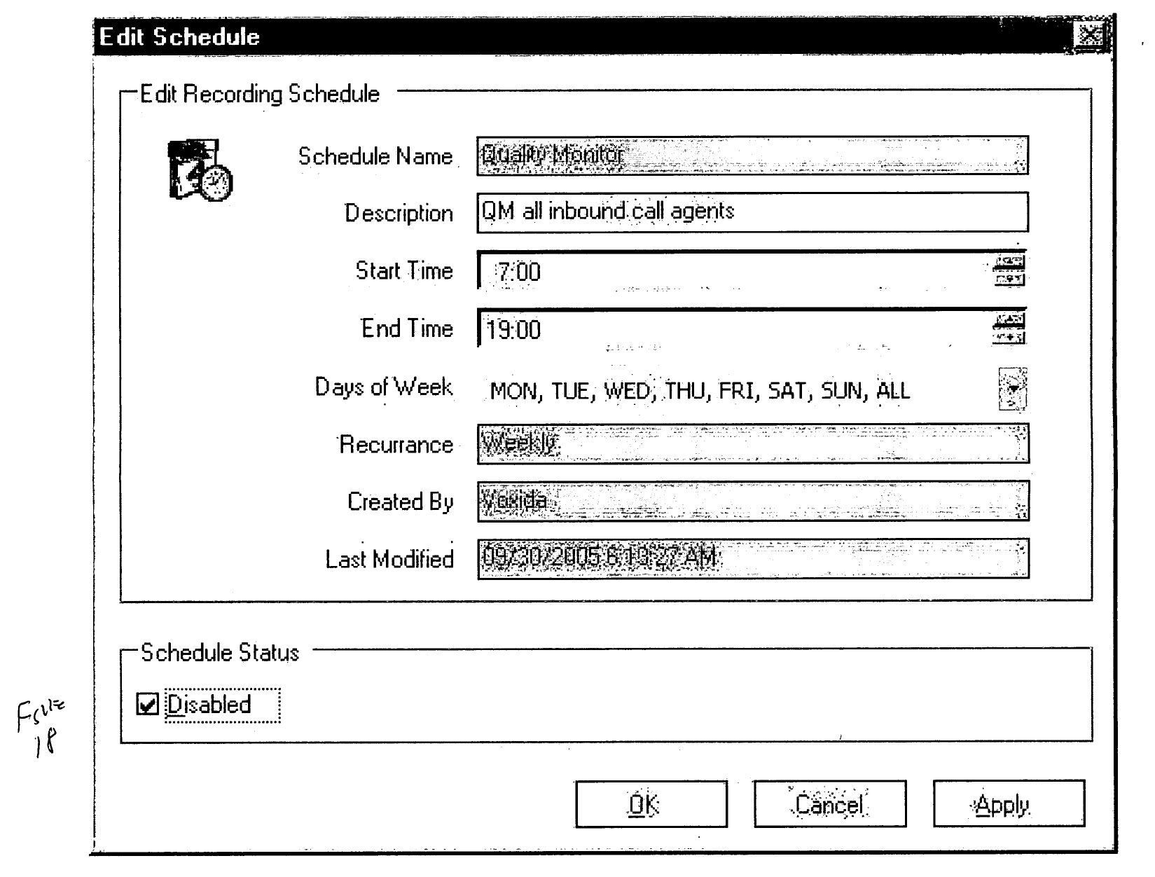

If the user wants to edit a schedule that is already created, he selects the schedule in the manage schedules summary view and click edit schedule. Alternately, the user can double-click a schedule in the list to open the edit schedule window. FIG. 18 is a screen shot showing editing of recording schedules according to the invention.

In edit schedule, the user can view the assigned data and modify the fields as desired. If he makes a modification, it updates the last modified date. When the user is satisfied with the schedule modification, click Apply. If the user decides not to modify the schedule, click Cancel to be returned to the manage schedule summary window.

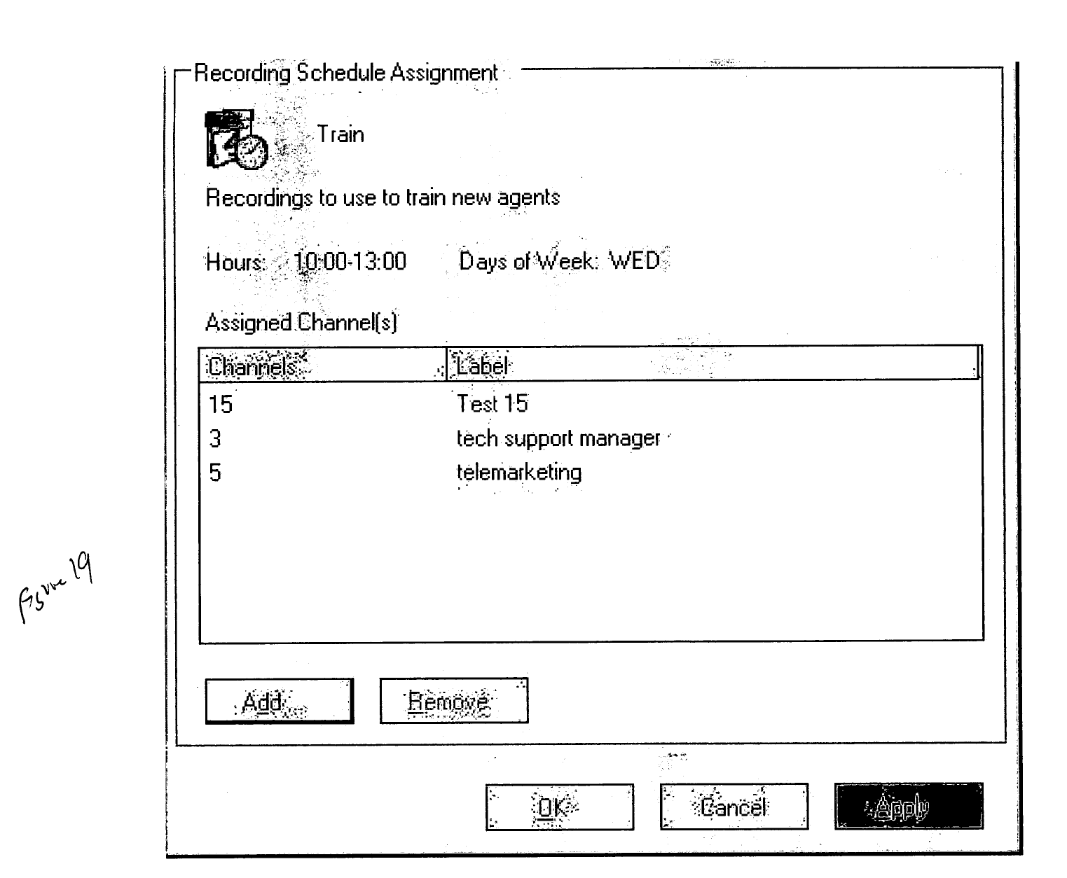

In the edit recording schedule assignment by schedule window, the user can view and modify what channels a schedule currently has assigned to it. FIG. 19 is a screen shot showing editing of recording schedule assignments to channels according to the invention.

The edit recording schedule assignment by schedule window provides the following schedule summary information:
Schedule name
Schedule description
The hours the Schedule records in 24-hour time
The days of the week the schedule records

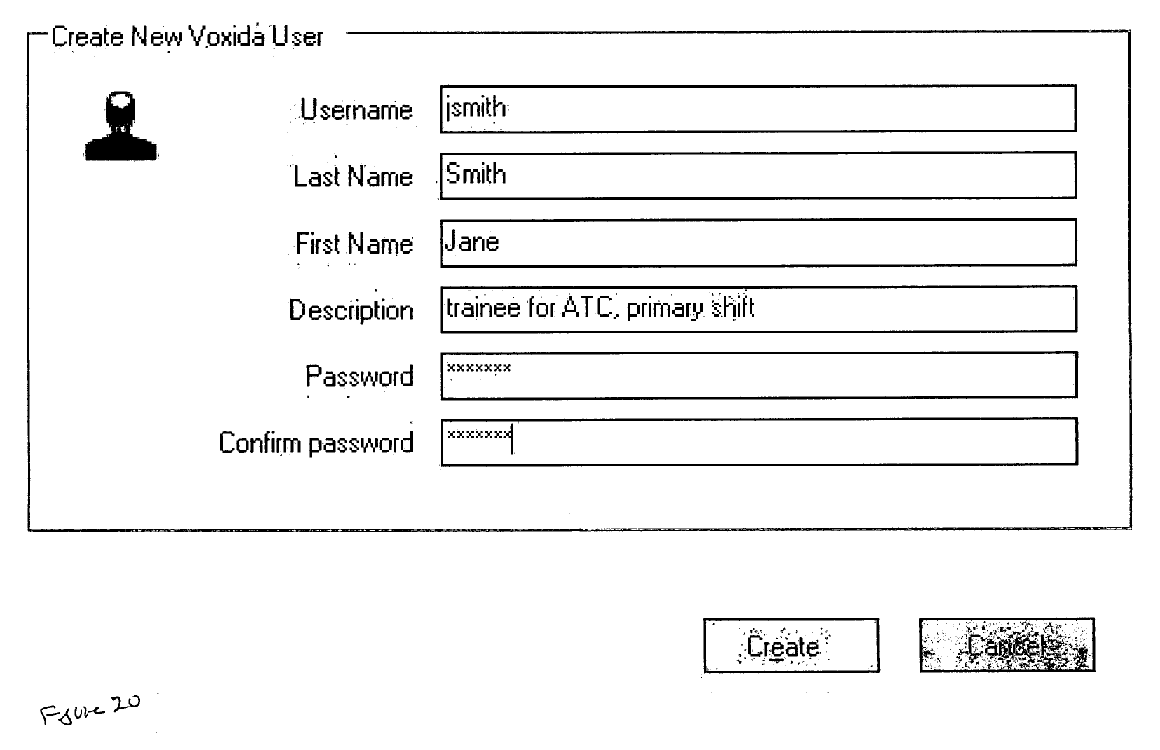

If the user wants to add a new user, click new user. The new user window appears. FIG. 20 is a screen shot showing creating of a new system user tab according to the invention. Fill in the data and save the work to create a new user.

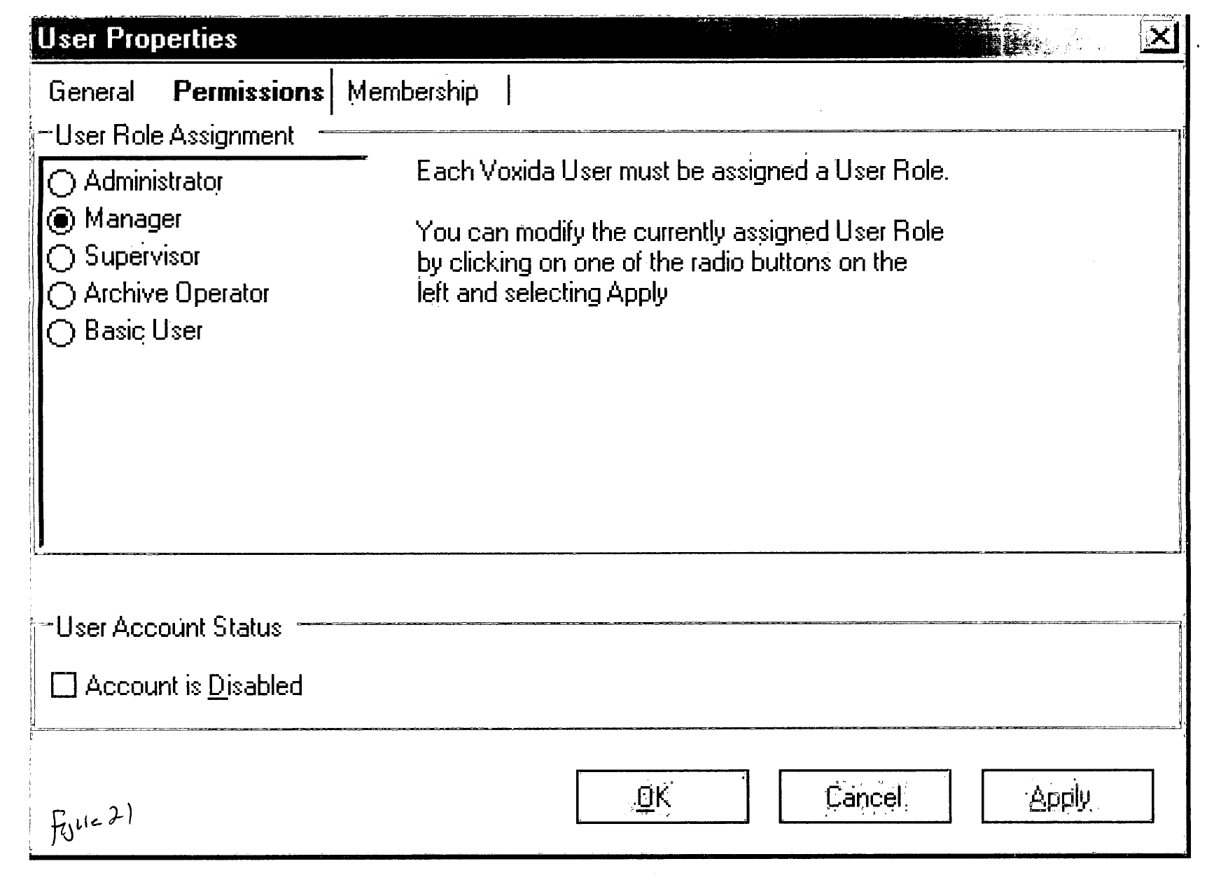

FIG. 21 is a screen shot showing assigning user rights according to the invention. The permissions tab enables the user to edit a user's role. One can disable an account by clicking:
Account is Disabled>Apply.

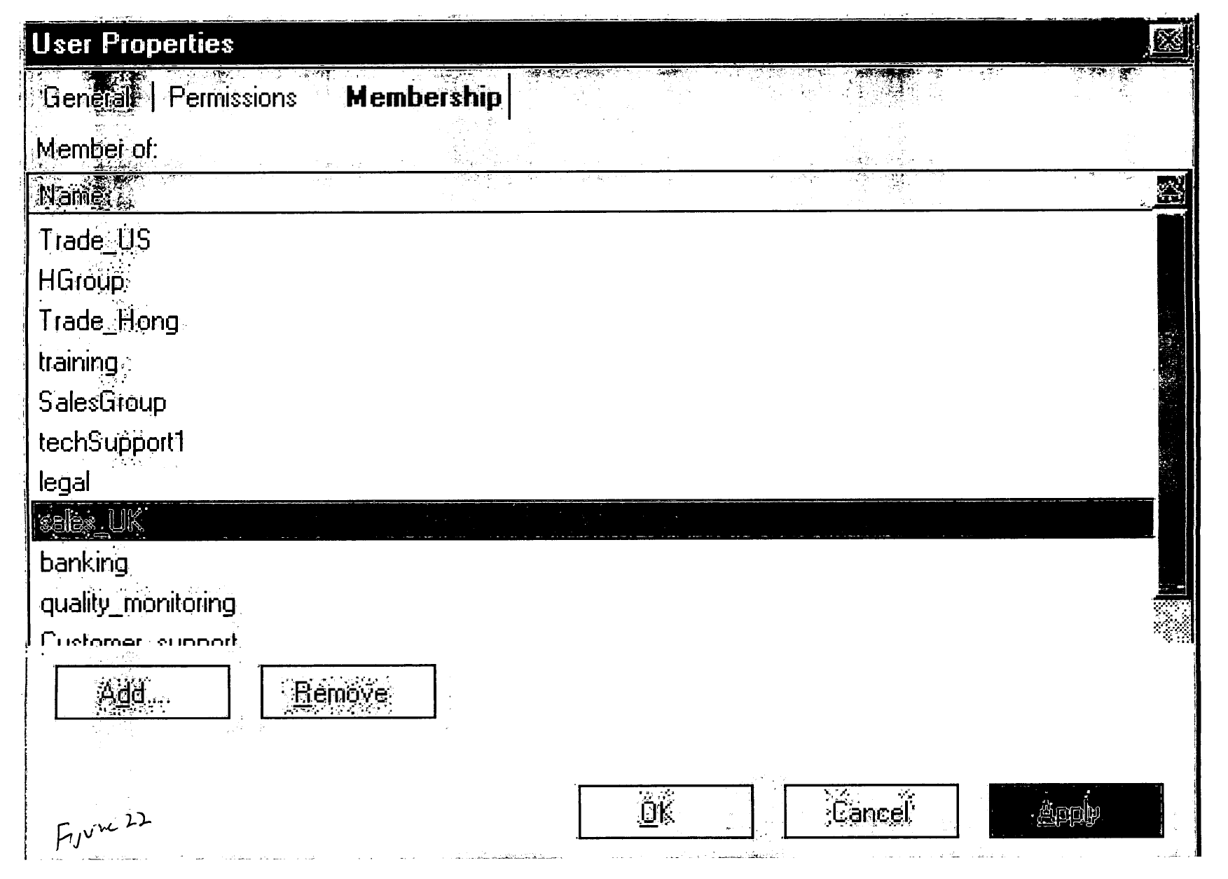

Under manage groups, the user can add, edit, delete, or modify permissions on a group-by-group basis. FIG. 22 is a screen shot showing assigning users to groups according to the invention.

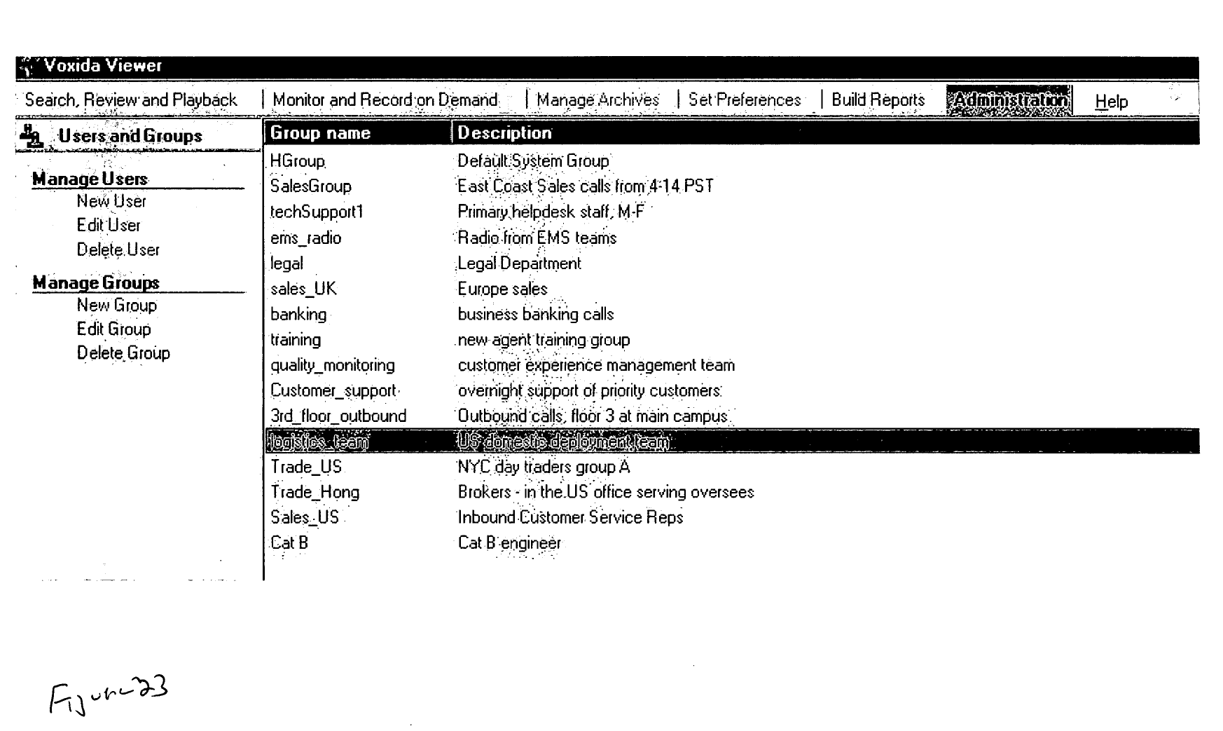

If the user wants to add a new group, click new group. The new group window appears. Fill in the data and save the work to create a new group. FIG. 23 is a screen shot showing a managing groups main view according to the invention.

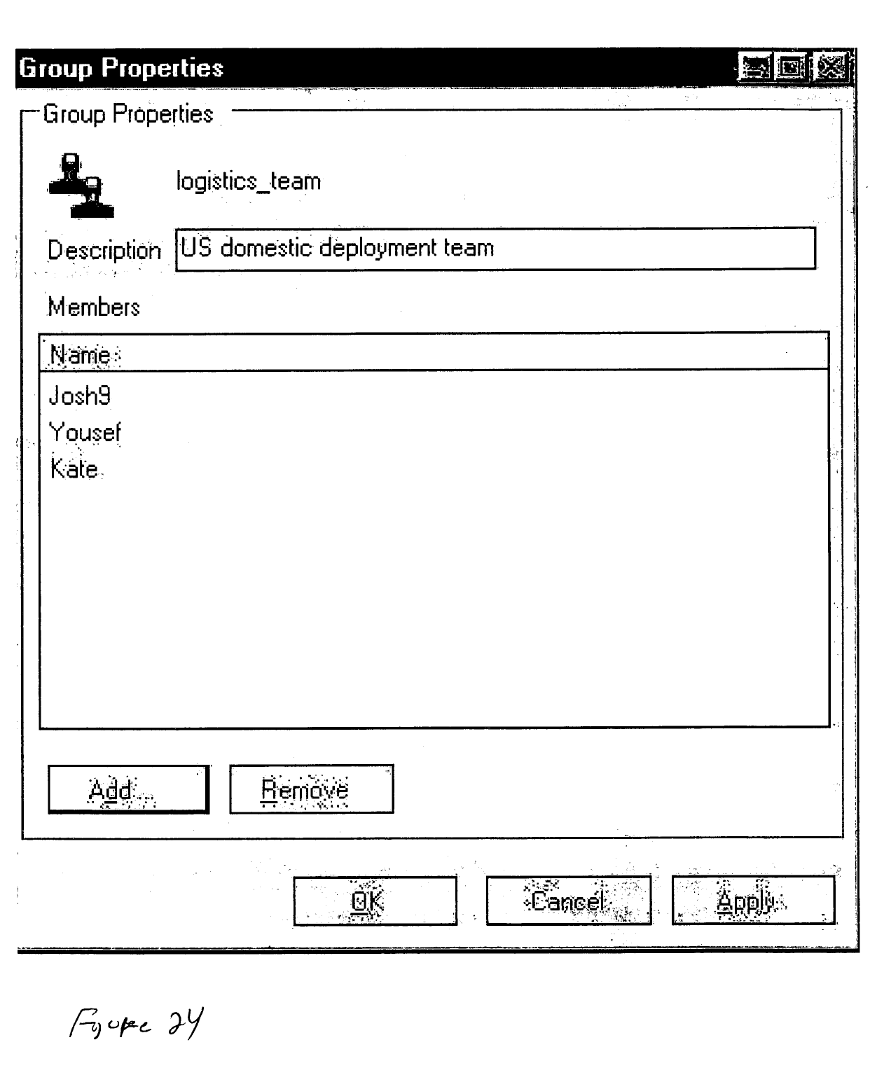

The user can also add members to his group from this interface. Click the add button and use the select users window to add members. FIG. 24 is a screen shot showing assigning group properties and members according to the invention.

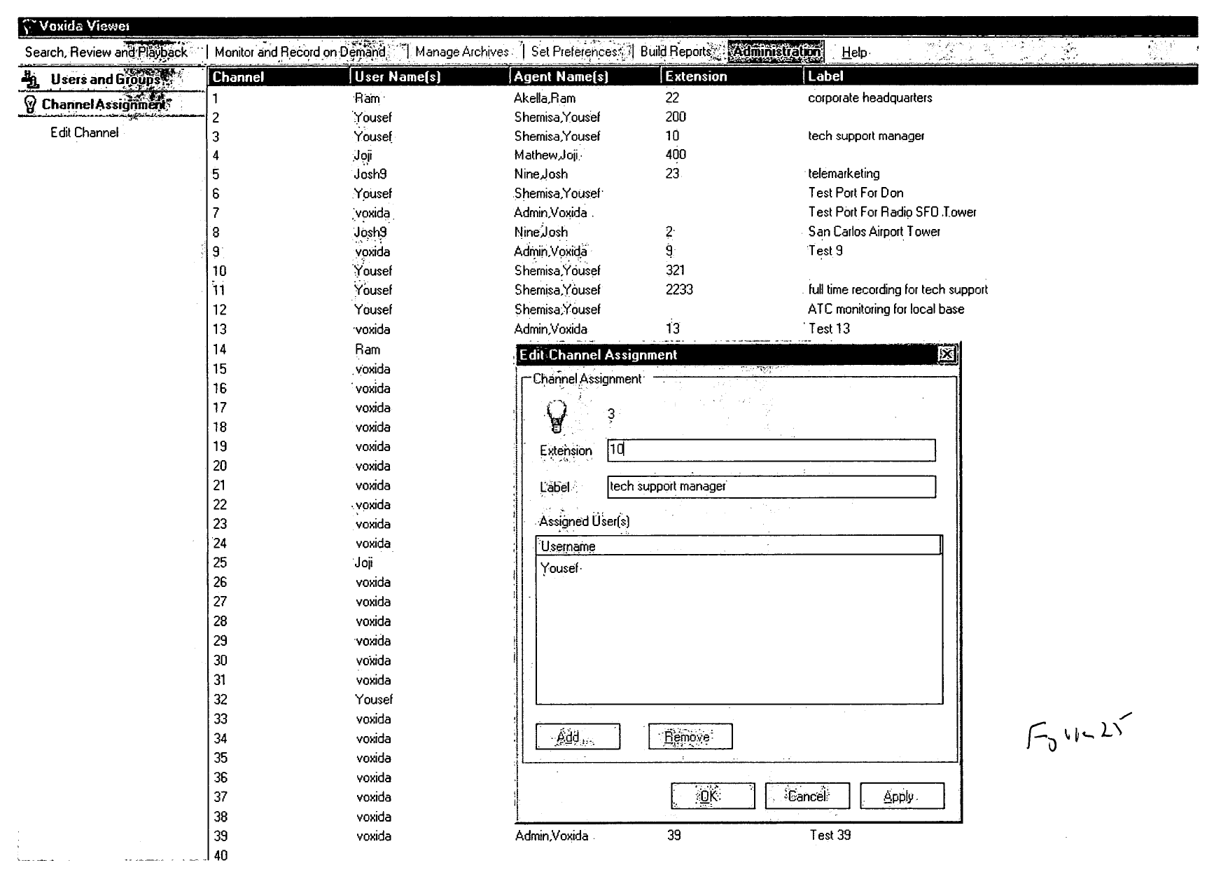

To edit a channel's assignment, select the channel and click Edit. The edit channel assignment window appears. In the edit channel assignment window, the user can edit the list of users assigned to the channel, and modify the channel label and description. Click OK to save he work. FIG. 25 is a screen shot showing edit channel assignment—assigning users to channels according to the invention.

Contextual Online Help Menu

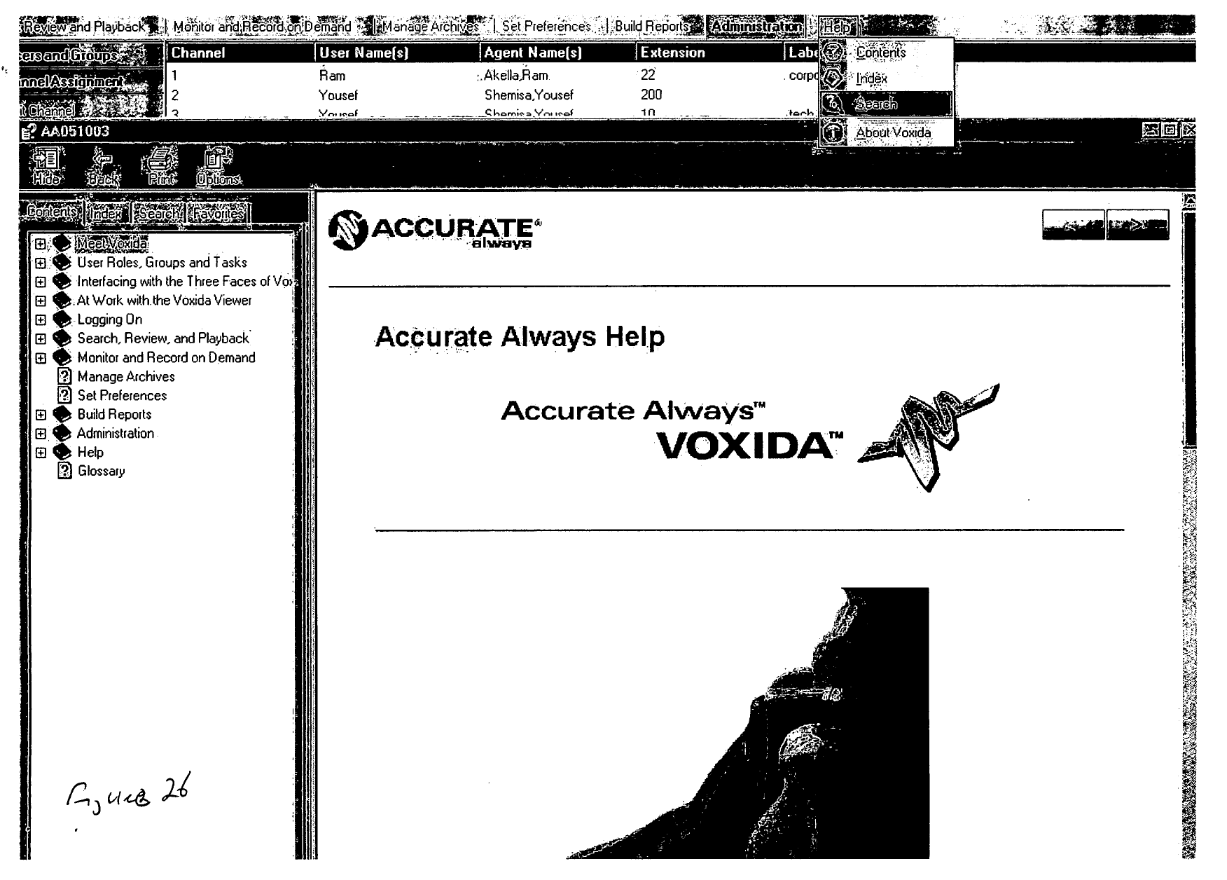

Online help is available at any time. Click the help icon. You can search for help by using the table of contents, the index or by a keyword search. FIG. 26 is a screen shot showing a contextual online help menu according to the invention.

Distributed Application

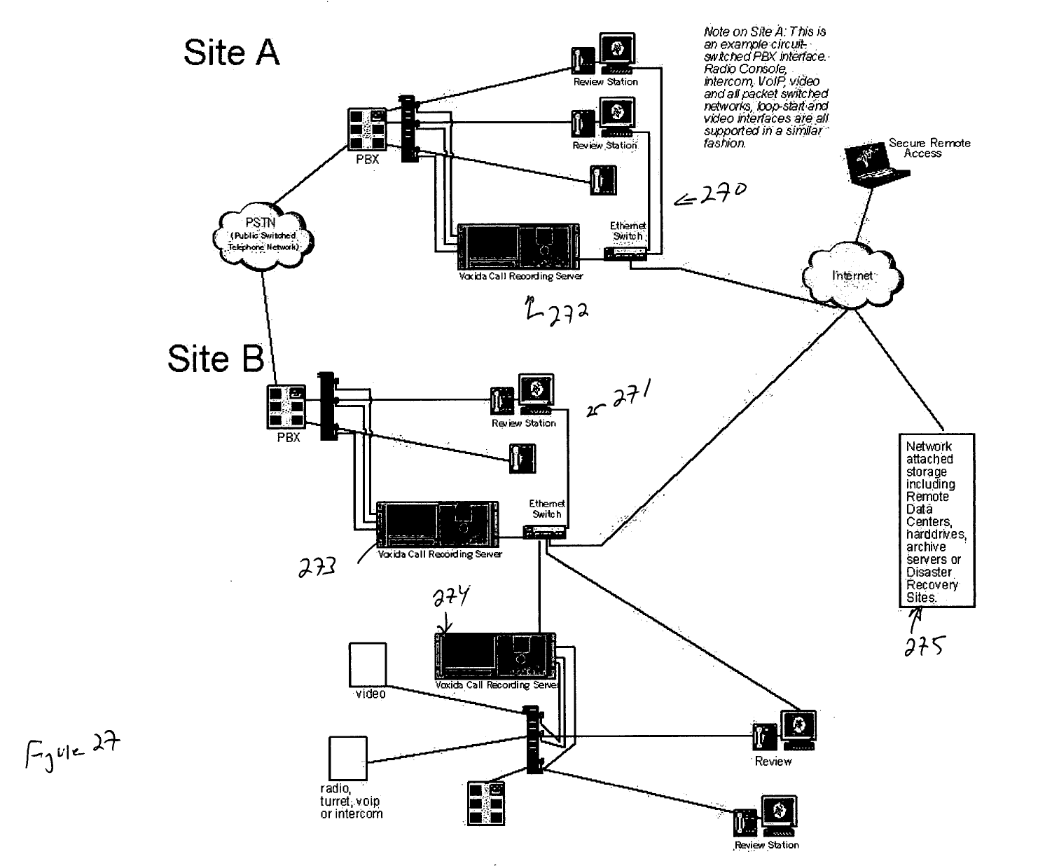

The call recording platform is a distributed application that enables multi-user, multi-site access and sharing of user permission profiles, database metadata and review of calls and full call detail records. Audio and video sessions (also referred to as calls) can be grabbed and stored in different locations. FIG. 27 is a block schematic diagram showing a distributed call recording platform according to the invention. Multiple sites, e.g. Site A (270) and Site B (271), and servers 272-274 can share a database 275, and all recordings can be played back over the LAN/WAN for secure, remote review. One can also live monitor locally or remotely.

In addition, the call recording platform can be organized (“distributed”) across multiple server machines to allow scaling out for fail-over and very high user load environments. In a distributed implementation, the individual components that comprise the server core are installed and operate on separate host machines and communicate between each other by means of TCP/IP network messages, using the same exact mechanisms as when installed and run on a single host machine.

This distributed paradigm supported by the invention allows the tailoring of individual computing and network resources by server core component load factor. This is done by adding CPU and host resources to the core components with the heaviest work loads, thus easily and cost effectively allowing for tailored growth while conserving precious host resources. Without this distributed architecture, the end user would need to expanding the system in its entirety

Database as New Paradigm

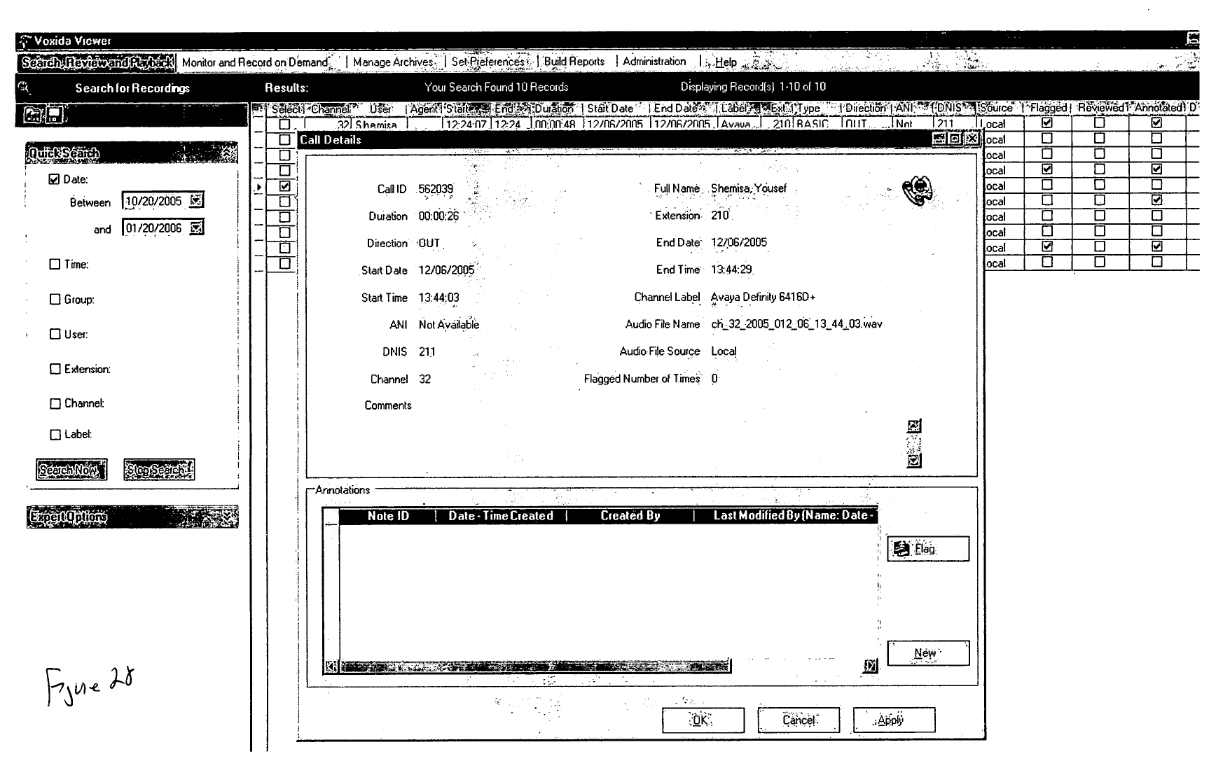

Call session related details are captured and stored in a database. This metadata is stored in a linked database. The platform links between recorded audio and metadata for playback as well as for archival of stored audio. FIG. 28 is a screen shot showing display of metadata that accompanies a call according to the invention. The platform populates database records with metadata and has a provision for hashing of this data.

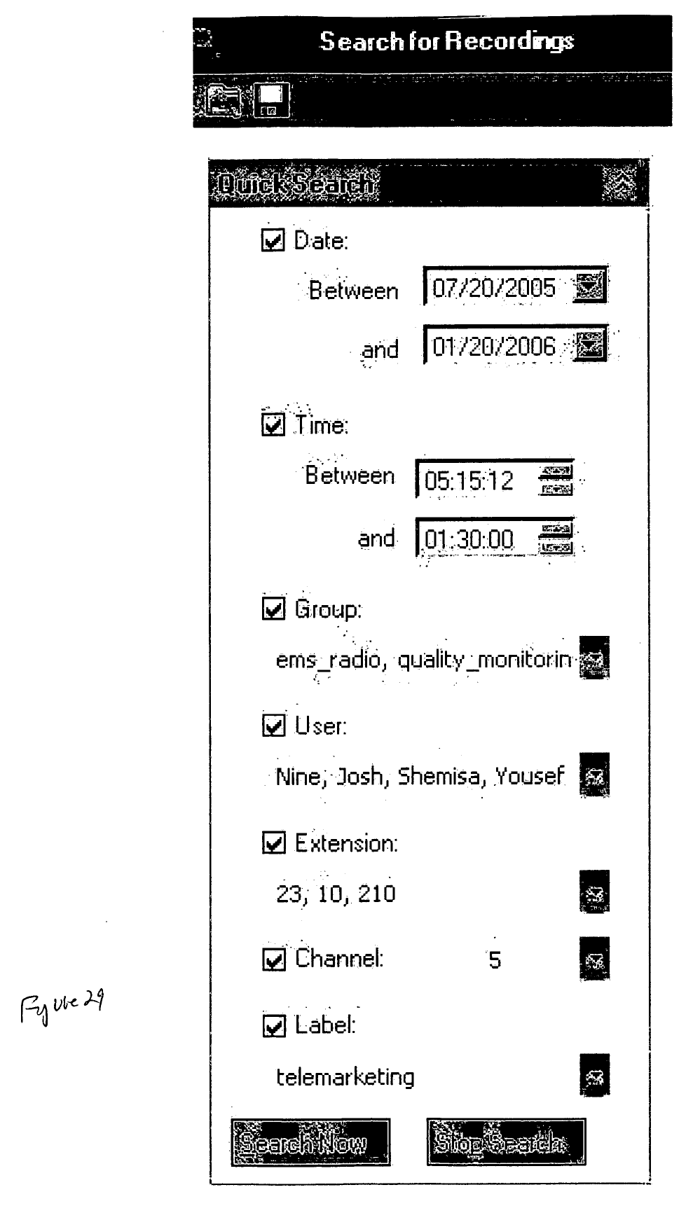

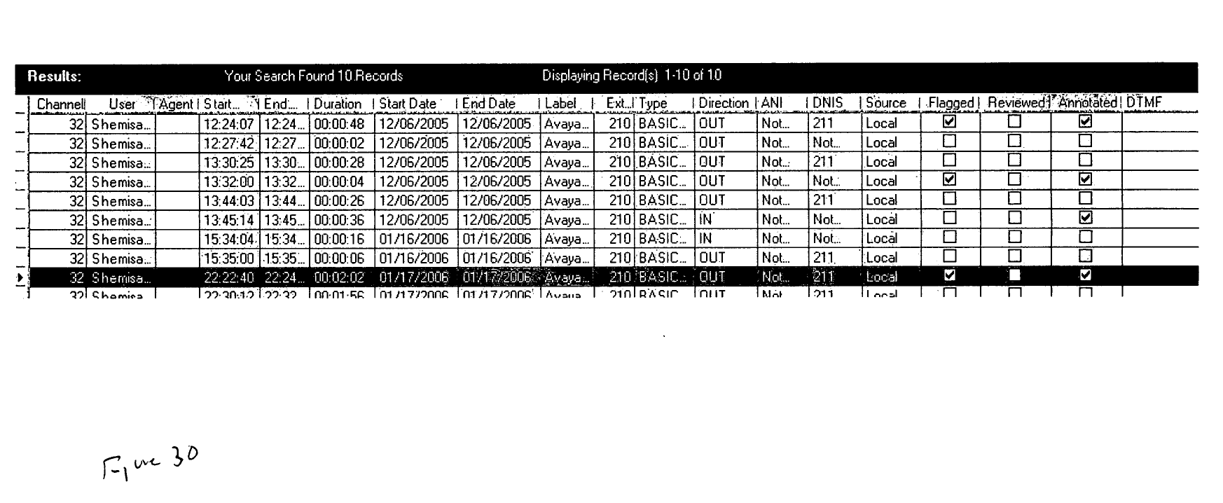

Metadata is read and displayed by the viewer client software application as well as the Commander administration client application FIG. 29 is a screen shot showing a simple query in a viewer for returning calls based on the logged metadata that fits the selected criteria according to the invention. FIG. 30 is a screen shot showing an example of a results list of call records returned for playback and review in the viewer according to the invention. The viewer client application also receives input from authenticated users for the purpose of adding post mortem information to the metadata stored and linked to a selected call record. The platform is designed in such a way as to enable the simultaneous input of metadata to any selected call record in the database, by multiple independent viewer users from different connected workstations, without data loss or corruption, while also updating each active viewer session's metadata display to reflect the latest changes.

A snapshot of each audio recording and its associated metadata is also taken by the archiver service at the time of a triggered archiving session. This snapshot is stored along with the archived audio on the target storage media for the purpose of server-disconnected review and playback, as well as to assist in data reconstruction in the unlikely event of a total system failure.

Player Independent Wav Format

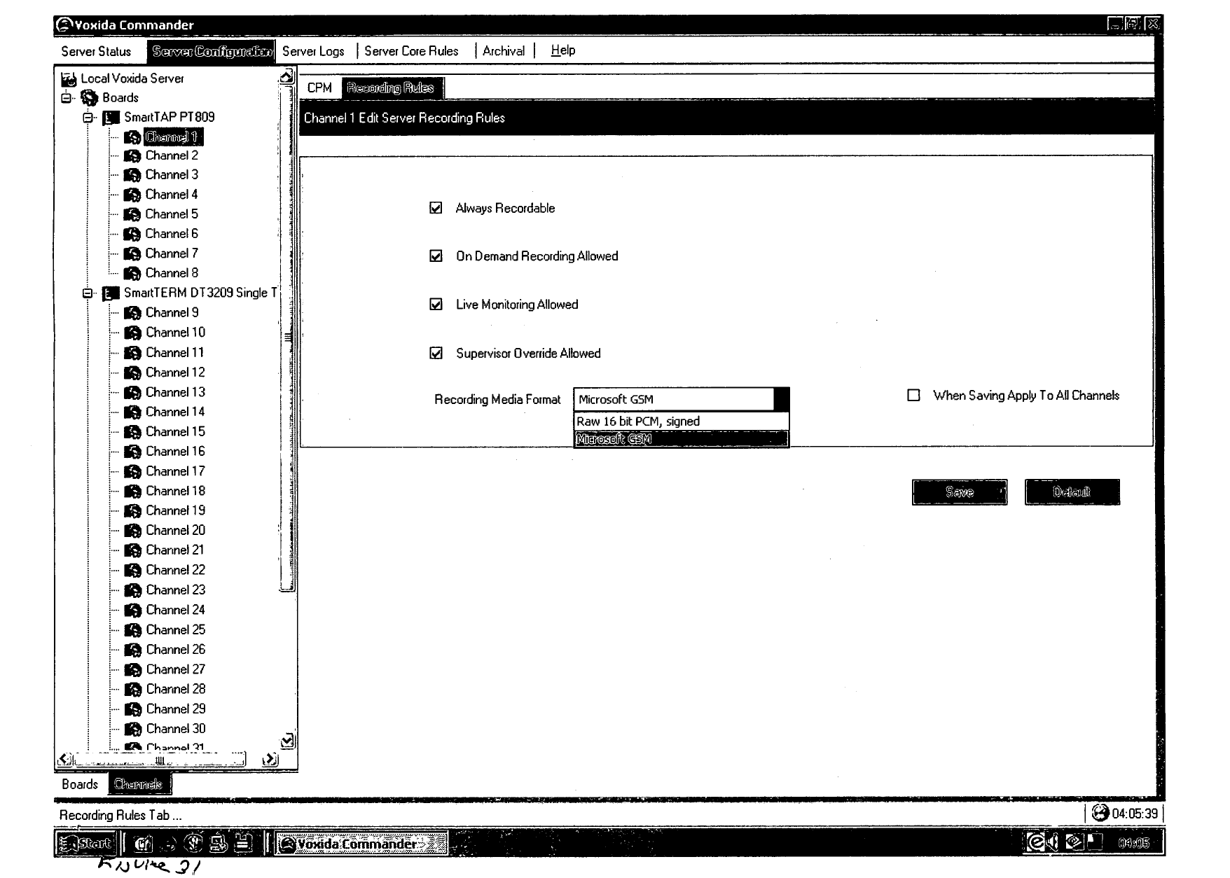

The platform operates with truly player independent audio format files. Users are not locked into using a specific, proprietary player. The platform does not write out parts of the recorded audio file which makes them unreadable with a standard software based media player, such as Windows Media Player. All call metadata are linked in the relational database and not included with the audio and/or video file, which means that the system is designed for future data portability and vendor independence. Recordings emailed, archived, or stored for the future are still fully accessible. FIG. 31 is a screen shot showing selection of recording formats according to the invention.

Live Monitoring: Real Time, Network Efficient Handling of RTP Streams

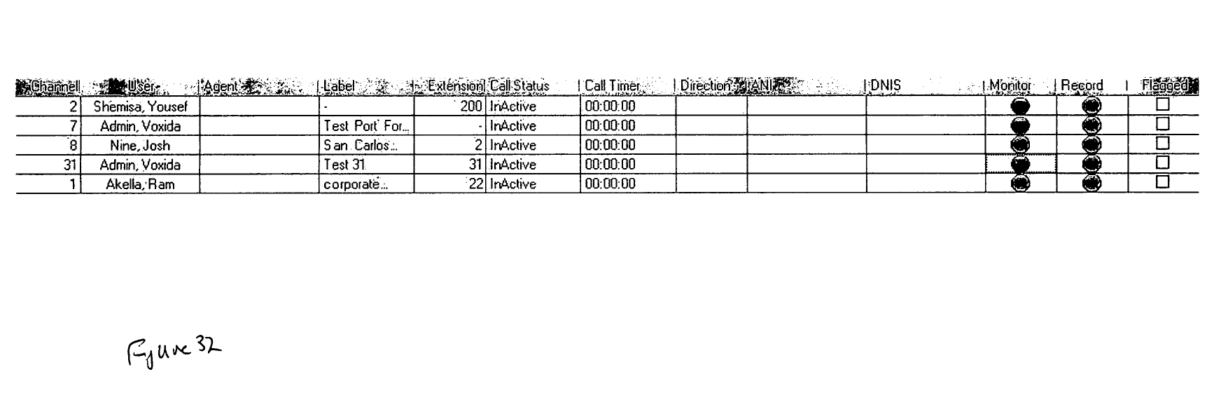

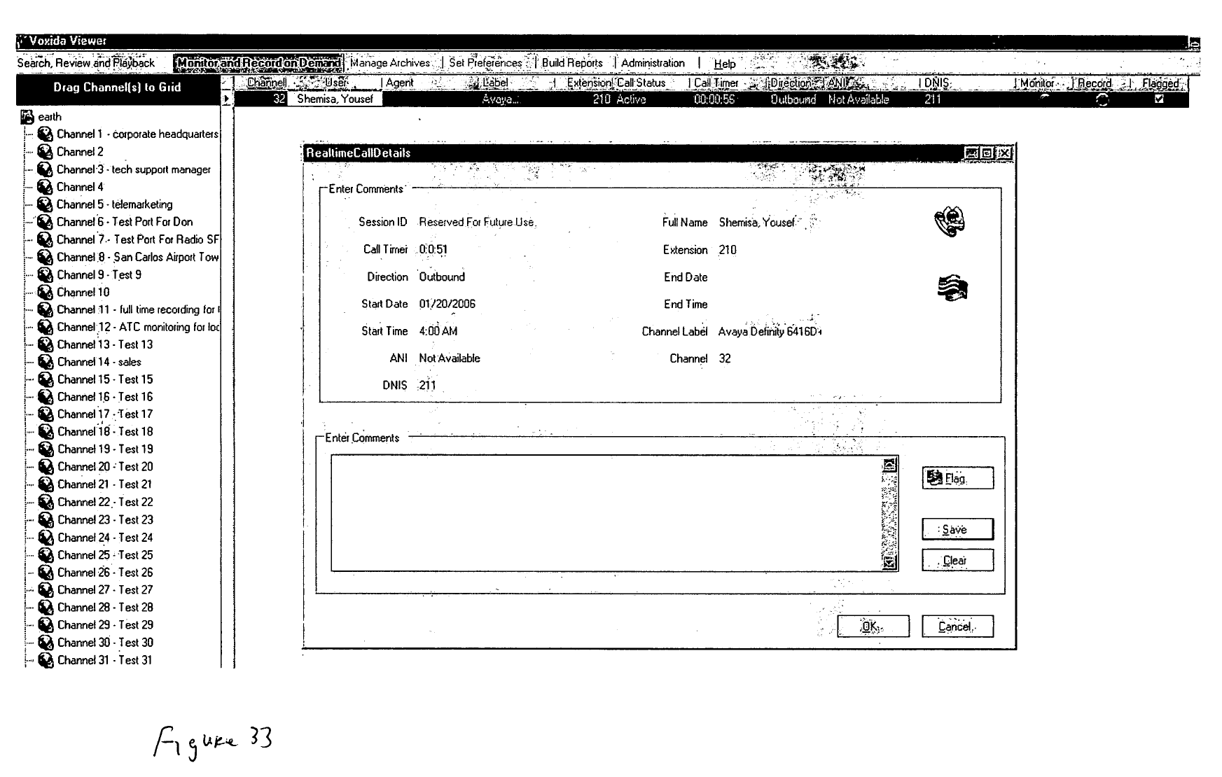

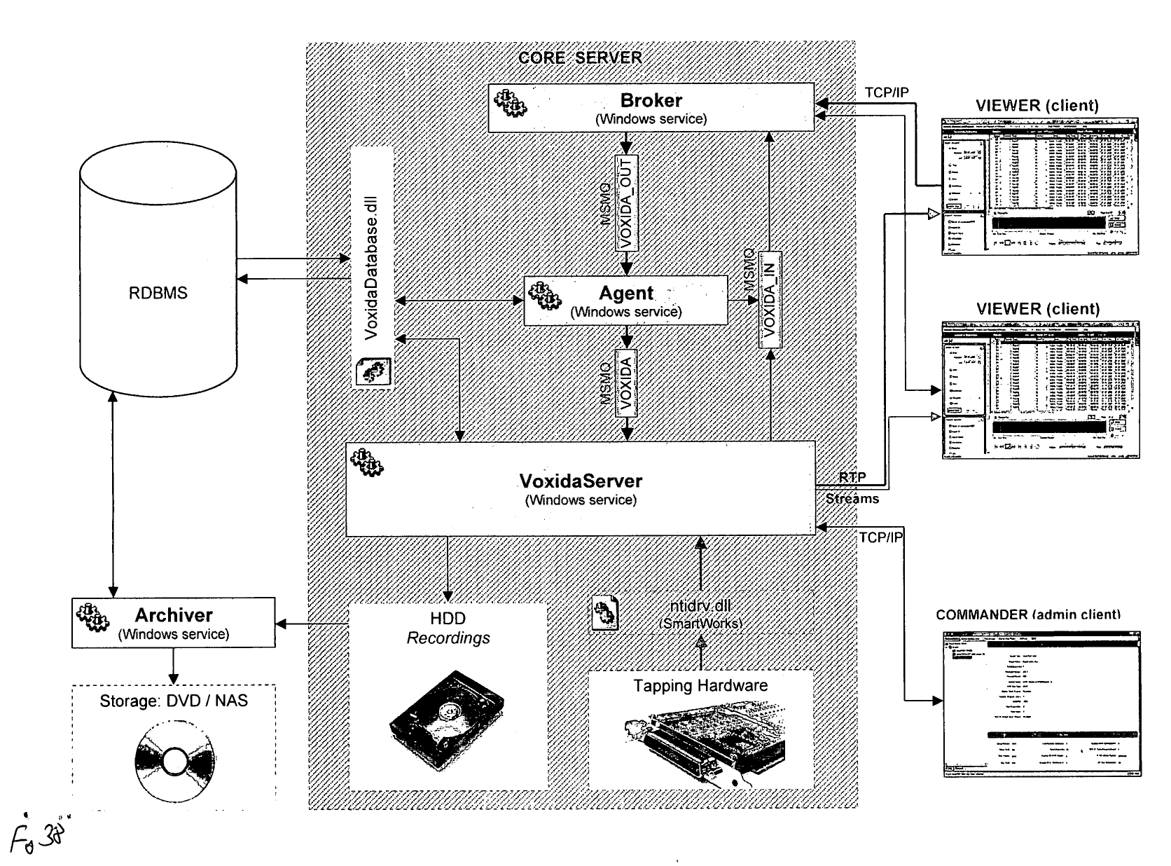

FIG. 32 is a screen shot showing live monitoring of multiple agents and extensions according to the invention. FIG. 33 is a screen shot showing a detail of live monitoring of agents and extensions according to the invention. FIG. 38 is a block diagram showing the flow of live audio from a tapped line to the viewer client application

Call Recording and Monitoring Tuned through Analysis of Verbose Logs

The platform is passively monitored. The invention further comprehends a process that uses the detailed logs generated by the platform, when operated in learn mode to fine-tune the customer's system. The preferred embodiment of the invention uses level 3 verbose logging outputs. The information from these logs is used to configure the platform onsite, without the conventional means, which require expensive, time consuming and often unreliable Computer Telephony Integration (CTI) with the monitored telephone switch/PBX. This learn-mode logging writes out a complete audit trail of the tapped line's signaling history, including proprietary D-channel communications between the terminal and the switch or PBX. This processed log becomes the basis for the creation of personality templates for each communication line being monitored. These personality templates are then used by the system to program the parameters of the Light Machine (VLM) and Message Parser (vMsg) engines of the platform. The following figures provide examples of screenshots of what is captured and analyzed.

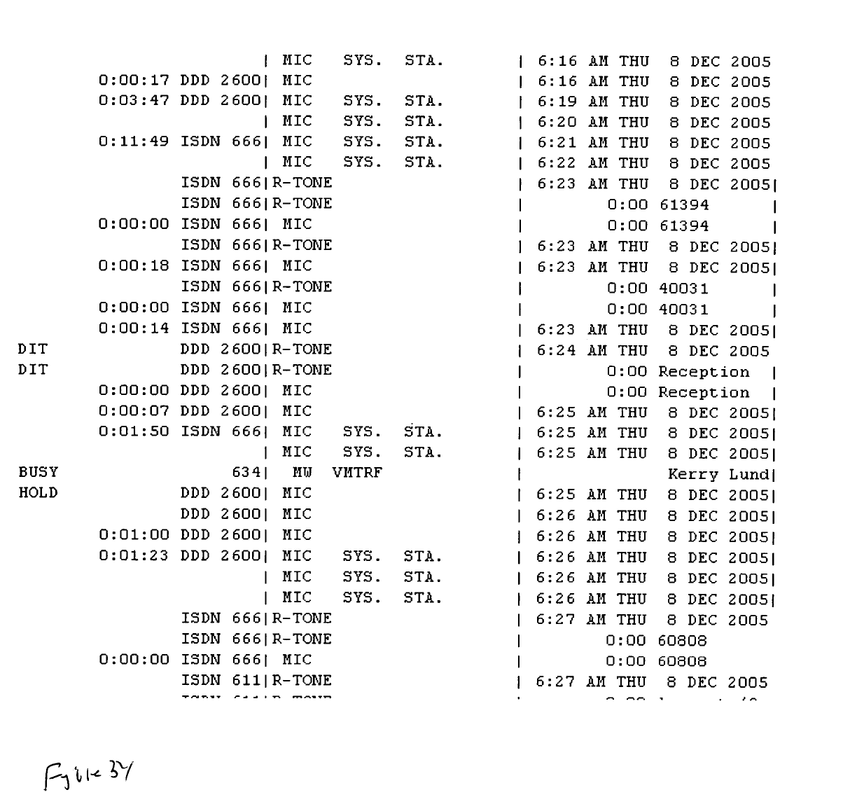

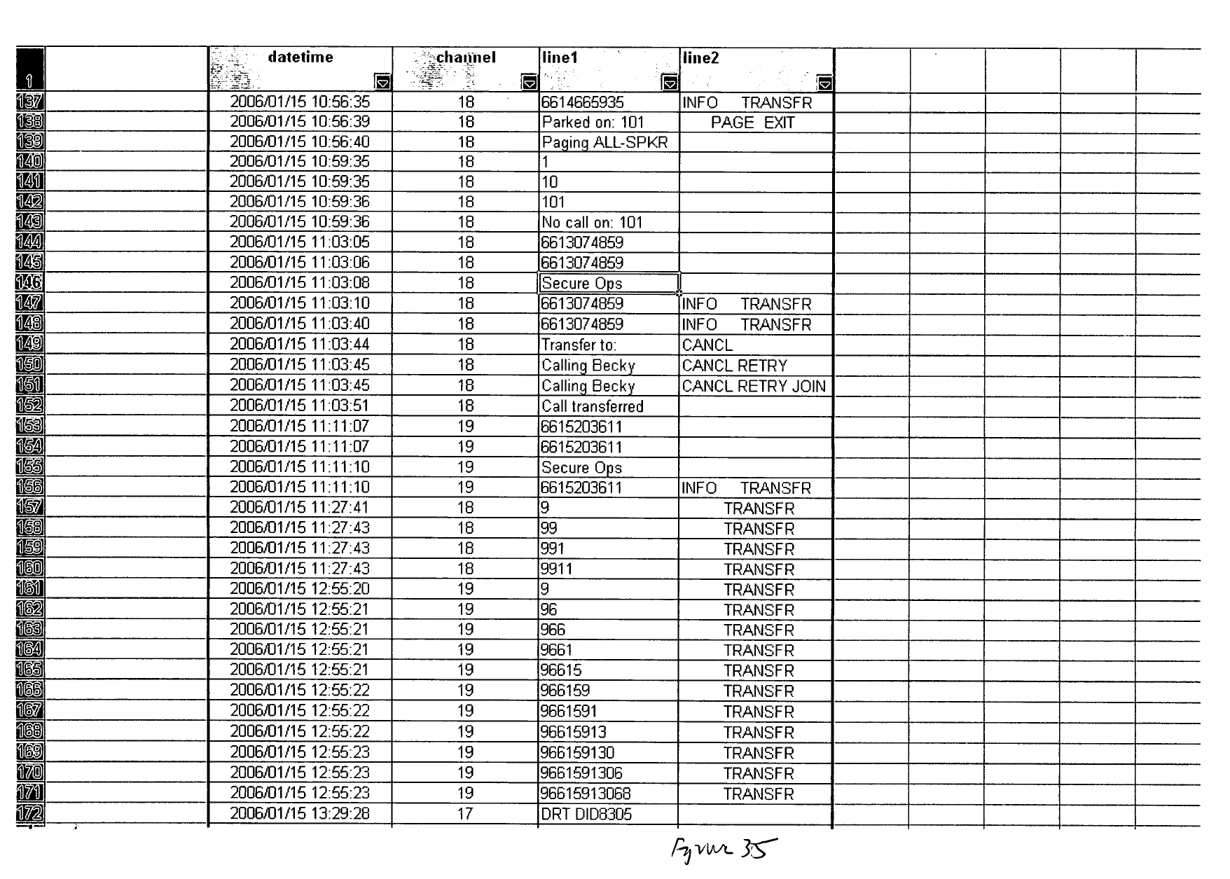

FIG. 34 is a screen shot showing a filtered raw log according to the invention. FIG. 35 is a screen shot showing the processed output of a typical logging session.

The Message Parser as a Tool to Gather Agent and Call Information

Depending on the PBX settings, the PBX sends display messages to the terminals that use this information to update their LCD screens on their computers and phones. By tapping a system that meets the requirements described above, the message change events can be captured and analyzed to extract information such as: ANI/DNIS, agent login name, agent login id, appearance. It can also be used to provide information about the direction of the call, although this may not be possible for all PBX(s). The module that does this analysis in the platform is the message parser, abbreviated as vMsg. The abbreviation vMsg is used to identify the message parser herein

Terms: Throughout this discussion, the following terms are used:
message—represents a message that it is sent from the PBX to the phones, and that is captured by the tapping system.

vMsg Capabilities: The vMsg has the following capabilities:
It is generic in the sense that there is no hardcoding in respect to the position of the information elements inside the messages;
All the configuration parameters that are required to configure the vMsg are loadable from database tables, so that the system can be easily set up for every particular customer's hardware settings (PBX configuration).
   Regular Expressions

The parsing of the messages is currently performed with the aid of Microsoft .NET Framework's regular expression pattern matching engine (regex), although this is not a constraint and any other regex engine can be used. Currently, the vMsg will recognize the following grouping construct names:

<ani>—ANI;

<dnis>—DNIS;

<agent>—the agent name;

<appearance>—the appearance that's being used;

<password>—the agent login id.

Call Direction

This module detects the call direction if it is deducible through message parsing. To accomplish this, the vMsg groups the message strings into two types:
call information—for the message strings that provide call information;
agent information—for the message strings that provide agent information.

For the first type (call information) there are three sub-types:
inbound call;
outbound call; and
no direction.

The meaning of this is that some call information message types imply the call direction. There is also the no-direction sub-type, for the case where the call information message does not provide information about the call direction.

The Classes

The classes reside under the namespace Voxida::Server::MessageParser:

CMessageType—defines the type of a message string: call information and agent information;

CResult—represents the result of the parsing operation on the message, and holds into its member variables the grouping construct values;

CRuleElement—puts together the regular expression string with the message type and the call direction (Voxida::Server::Server core::CCallDirection)—if applicable for that particular message type;

CRule—contains a list of rule elements (CRuleElement). The parsing is done through this class, which has a method called “parse”. When this method is called, the list of CRuleElement objects is enumerated and the search for a regex match begins. If a match is found, the parse method returns a CResult object holding the result of the parsing;

CRuleManager—it is a helper class that loads all the parsing rules from the DB.

The DB Tables

The DB tables are very similar to the classes described above, in terms of data structure:

vMsg_MessageType

vMsg_CallDirection

vMsg_Rules

vMsg_RuleDetails

There is also a table called “VoxidaChannelSettings”, that apart from other configuration parameters on a per channel (port) basis, holds the vMsg rule ID that is applied to that channel, and an enable/disable “flag.

Light Machine: Tailorability for Market Applications

Customer site PBX, regardless of make and model, can be configured in countless ways. One embodiment of the invention is referred to as the Light Machine, which interprets the call events (on-hold, etc.). These events serve as customer site specific triggers for recording and other call metadata trapping. The Light Machine is a significant advancement because it provides call recording server tailorability and call record message field population without the need for costly computer telephony integration. The Light Machine is used onsite or by using a secure web client. It is used at time of install or when a customer needs support for new equipment or for the call recording platform to otherwise adapt to changes at the customer site.

A call recording server installed on a customer's site can be rapidly optimized to gather, store as metadata in an object oriented database that is linked to the call audio database and operate with highly tuned call recording and monitoring triggers for comprehensive, custom call session management. Using the Light Machine, one may respond to diverse market sectors needs, integrate with proprietary PBXs, and truly have each platform learning on the job from the first day of installation.

Depending on the PBX and type of terminals that are connected to it, these terminals can display status information. Next to a button that is used to answer/terminate a call, a particular appearance of an indicator, e.g. colored LEDs, indicates such aspects of line status as ringing, answered, transferred, and on-hold.

By tapping a system like the one described above, the changes in the colored LED states can be captured, analyzed and used to trigger the start/end of recoding a call. It can also be used to provide information about the direction of the call, even in complex call transfer/routing scenarios. We have named the module that does this analysis in the system “Voxida Light Machine”, abbreviated as VLM. The abbreviation (VLM) will be used throughout this section from this point on.

Terms: Throughout this document the following terms are used:
line—is used as a synonym for line appearance;
light—is used as a synonym for LED (light emitting diode), LCD or other line status or activity indicator provided by a communications terminal for visual feedback to the user.

VLM Capabilities: The VLM has the following capabilities:
It is generic in the sense that there is no hardcoding in respect to the light colors, e.g. red, green, etc., number of colors per line, light type, e.g. on, off, flashing, etc., or the actions, e.g. start recording, stop recording, detected direction: inbound, etc. that are triggered by a specific line light state;
All the configuration parameters that are required to configure this general purpose light machine are loadable from database tables, so that the system can be easily set up for every particular customer's hardware (PBX, terminals) and settings (PBX configuration).
   Implementation Details

To be generic as described above, everything is an object, or a class, inside the VLM:
CLightColor—defines the light color, with its name, description and a bit-mask. The bit-mask is used to tell if a detected light color state change event received from the tapping hardware refers to a particular color type, e.g. red, green, etc.;
CLightState—defines the states that a light can be in, such as “on,” “off,” “flashing,” etc. Beside the name and description, there is a member variable that creates the relation between the light state and the event type that is received from the tapping hardware;
CLight—represents a light, with its color (CLightColor) and the state (CLightState);
CLineLightState—defines all the lights with their colors and states that are associated with a line. It thus is a collection of lights (CLight);
CLineState—defines the state of a line, in terms of the line light state (CLineLightState), the call state, such as ringing, on-hold, answered, etc., and the detected call direction, e.g. inbound/outbound/not detected;
The last class—CLineState—can be associated with an action trigger:
CTrigger—defines the actions that are taken when a line has a particular line state (CLineState). The actions can be, for example: call start, call end, start recording, stop recording, detected call direction:

inbound, and detected call direction outbound: outbound. This class has a method named fire that puts other components into action to perform the actual recording.

The classes are grouped into what are referred to as rules which are loaded from the database:

The above classes are grouped into rules, that are loaded from the database:

CRule—defines a rule, which is a collection of several elements described below;

CRuleElement—puts together a line number and a line light state (CLineLightState) with the action trigger (CTrigger) that must be fired when that line light state is met for that particular line;

To make things easier there are several manager classes:

CRuleManager—manages the collection of rules (CRule), including the DB configuration loading. Note: several classes in the hierarchy have DB configuration loading methods, so that the whole module is better structured;

CLightColorManager—manages the collection of all the possible light colors. This is a helper class, that's also a factory for CLightColor objects, given the light color ID loaded from the database;

CLightStateManager—manages the collection of all the possible light states. This is a helper class, that's also a factory for CLightState objects, given the light state ID loaded from the database. The DB tables are very similar to the classes described above, in terms of data structure:

vlm_LightColors

vlm_LightStates

vlm_Lights

vlm_LineLightStates

vlm_LineLightStateDetails

vlm_TriggerTypes

vlm_Rules

vlm_RuleDetails

There is also a table called “VoxidaChanne|Settings”, that apart from other Voxida configuration parameters on a per channel (port) basis, holds the VLM rule ID and enable/disable flag.

There is also a database table, referred to as VoxidaChannelSettings, that apart from other configuration parameters on a per channel (port) basis, holds the VLM rule ID and enable/disable flag.

USER ACCESS: PROFILES AND PERMISSIONING granular user permissions that allow authenticated users to only access calls from Groups, channels, extensions or other user defined criteria locally or remotely.

The platform allows for the adjustment of user and group permissions without requiring a redesign of the database.

Voxida Modules (Server Side)

VoxidaServer Service

VoxidaServer is the core of the recording system. It interfaces with the tapping hardware library (dll) to detect calls and record them, and gather meta data information about these calls.

Main VoxidaServer components:
Event Listener—receives information from the tapping hardware, on a per channel basis. This information is analyzed by the following sub-components:
   Rule Engine—Holds a list of recording related triggers, such as “start session,” “stop session,” “start recording,” “stop recording,” based on the event codes that are passed from the tapping hardware. It can also provide information about the call direction. It actually describes a “Call State Machine”;
   VLM (“Voxida Light Machine”)—Analyzes detected light events that are passed from the PBX to the terminals, and fires triggers such as “start session”, “stop session”, “start recording”, “stop recording” whenever appropriate. It can also provide information about the call direction.
   Bidirectional ACTD FSM—The “Bidirectional Activity Finite State Machine” is used to detect silence (idle line) for both directions (downstream and upstream) for the systems where the tapping hardware provides this differential information. Its main purpose is to stop the recording when the silence has been detected;
   vMsg (“Voxida Message Parser”)—Analyzes the tapped LCD messages that are passed from the PBX to the terminals. It is thus capable of providing useful information such as: ANI, DNIS, call direction, agent name, agent login ID, appearance etc. It does this by using a regular expression engine. For a better understanding, please view the chapter that details the vMsg;
   Digit Processor—Analyzes the digits pressed on the terminals to detect agent logins (login, logout) to hunt groups. It does this through a regular expression engine by parsing the stack of detected digits at a given moment in time.
Session—It is the representation of a call. These objects are created each time a call has been detected, and are released when the call is terminated. It is capable of recording the call and storing the meta data related to the call. It has the following sub-components:
   Recorder—It does the actual audio recording, by working closely with the tapping hardware's library, and storing the captured audio data to the hard disk. It supports several file formats;
   CSM—The “Call State Machine” makes use of the rule engine described above to filter the actions that might be taken at a specific moment in time. For example, it does not allow the recording to take place unless a specific call state has been entered;
   Event Manager—Processes particular events received from the tapping hardware. For example, it gathers the detected DTMF digits that provide useful information about the call (like the dialed number for an outbound call);
   Call Detail Record—Holds all the metadata information about the call, like: call start time, call end time, call direction, recorded file path, recorded file size, ANI, DNIS, hunt groups (that the agent logged into), signal type, DTMF digits, agent name, agent login ID and so on. When the call is terminated, this information is stored in the database.
      Broker Service

The broker is a TCP/IP server, as seen from the client (VoxidaViewer) side. It manages client connections by having a connection pool, with advanced session management. All the requests that arrive from the clients (viewer instances) are passed along to the agent module, described below. The information that is to be passed to the clients arrives both from the agent and the server modules, depending on the type of information. The communication with these modules is done through a message service (MSMQ).

Agent Service

The agent forwards boker requests,—depending on the request type—to the server and/or handles database requests through a DB component (VoxidaDatabase.dll), in which case it replies directly to the broker. The communication is done through a message service (MSMQ).

Archiver Service

The archiver monitors the available free space on the hard disk partition that holds the recorded audio files, and, based on configurable free space quota levels starts the archiving process. It archives the necessary amount of files to free the hard disk space until it reaches the configured free space quota level.

The archiving process can also start on a schedule basis.

The media type that the archiver uses can be:
CD/DVD—the burn can be done using multiple write devices, in sequential mode filling up the media that has the less space left first, or in mirror mode, when the exact same information is stored simultaneously to several disks;
NAS—network attached storage media visible as a network shared drive;
/dev/null—null device, as with the UNIX/dev/null. This is used to free the space occupied by very old files, when no archiving (CD/DVD or NAS) is required.

Along with the audio files, this module also archives a file containing all the metadata information about the calls, so that a viewer could display this information even when no connection to the server is possible (working offline mode).

The Archiver also provides the aging process for the archived files. This means that the module can be configured to delete the local copy of the archived files only after a specified time has elapsed from the moment when the files were archived.

Controller Service

This module is used to start the other services automatically, so that the recording can take place without the user intervention. Though the controller can manage any Windows service, the archiver normally starts on its own because it is sometimes needed to work when the rest of the services are stopped, or it is even installed on a separate machine.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A digital voice recording platform for live monitoring of calls, voice logging, incident reconstruction, compliance, and liability reduction, comprising:
a LAN/WAN based server system for providing call data access from at least one networked client workstation;
said system comprising any of digital and analog interfaces, and support for any of PBX systems and VoIP;
means within or associated with said system for detecting call triggers to automatically respond to line signaling events to capture associated call data;
means within or associated with said system for providing a plurality of call recording options and modalities;
search means within or associated with said system for accessing said associated call data;
means within or associated with said system for archiving and management of said associated call data; and
means within or associated with said system for allowing a user to perform any of annotating or emailing a call, creating custom search fields, tracking a case or customer, or burning an archive of recorded calls.

2. The platform of claim 1, said client workstation comprising:
a viewer comprising an intuitive graphical user interface (GUI) for agents and supervisors, said viewer providing any of a local or remote TCP/IP interface for business rules and user administration, call data retrieval and search, record annotation, playback, monitoring, and transcription of calls.

3. The platform of claim 1, further comprising:
an interface for a systems administrator to configure said server system, said interface comprising full catalog data management controls and allowing administration of server system preferences (settings).

4. The platform of claim 1, further comprising:
a server core module for providing an interface for any of IP network and telephony/radio hardware, and for enabling call data logging to a database manager, said server core module monitoring and handling media recording and online volume data, as well as managing archived catalogs in a database and handling archive creation.

5. The platform of claim 1, further comprising:
a user scheme, in which users are assigned a role that is governed by a list of rules that permit each user to perform certain tasks and access information, wherein each user is assigned a role by a user having an administrator role;
wherein primary roles comprise any of:
Basic User;
Supervisor;
Manager;
Archive Operator; and
Administrator.

6. The platform of claim 1, wherein users are assigned to groups which each comprise a set of users; and wherein according to user role status and permissions that it allows, a user is allowed to live monitor, record, comment, or search, review and playback calls that are received by the user's group.

7. The platform of claim 2, said viewer comprising a window having a plurality of tabs that group related tasks together to allow a user to conveniently and quickly capture, monitor, retrieve, and review vital data.

8. The platform of claim 7, said viewer further comprising:
a select server menu that, when expanded, provides a list of servers on the network.

9. The platform of claim 7, said viewer comprising any of the following tabs:
Search, Review, and Playback;
Monitor and Record on Demand;
Manage Archives;
Set Preferences;
Build Reports;
Administration; and
Help.

10. The platform of claim 7, wherein when a user logs in, a user profile and user role is communicated to said viewer; wherein said viewer only shows tabs that are available to said user's user group; and wherein call records that a user has access to varies by user role status and group membership.

11. The platform of claim 1, said search means further comprising:
means for allowing a user to search for recorded calls conveniently, and with a level of granularity that is desired by said user;
wherein said user can search for calls to review and playback any time that said user has a search, review, and playback tabbed interface open.

12. The platform of claim 11, further comprising any of:
a quick search menu, and an expert search menu that allows a user to query a database for records that fit a more detailed criteria than that available using a quick search.

13. The platform of claim 11, wherein said viewer returns all call records that match search criteria; wherein said call records are returned in a results grid that provides vital data about a call, at-a-glance; wherein said results comprise any of the following:
Agent ID and Agent Name;
Basic User;
Group;
Start Time;
End Time;
Start Date;
End Date;
Extension;
Automatic number identification;
Dialed number identification service;
Direction, incoming or outgoing call;
Channel;
Source; and
Flagged.

14. The platform of claim 2, said viewer further comprising:
a playback area for displays a graphical representation of call data and for providing information about a selected record's start and end time;
wherein upon clicking play, a user can watch a playback progress in a current position field, as well as watching graphical call data progress.

15. The platform of claim 1, further comprising:
means within or associated with said system for providing a multi play function that allows a user to play a plurality of synchronized call records at the same time.

16. The platform of claim 2, said viewer further comprising:
an audio editor for editing a call.

17. The platform of claim 2, said viewer further comprising:
a call detail view that provides all call data and fields for augmenting call record data.

18. The platform of claim 2, said viewer further comprising:
an annotation detail for annotating call.

19. The platform of claim 1, further comprising:
means within or associated with said system for live monitoring of a call that is in progress, whether or not it is currently being recorded.

20. The platform of claim 1, further comprising:
means within or associated with said system for commenting a call quickly while a user is monitoring and recording the call to share up to the minute vital call data across the network.

21. The platform of claim 1, further comprising:
means within or associated with said system for providing periodic reports to get regular analytics for a call center.

22. The platform of claim 1, further comprising:
administration means within or associated with said system for creating, editing, assigning, and deleting recording schedules; wherein a recording schedule comprises a rule that tells the platform when to record on a given day; wherein a recording schedule can be applied to one, many, or to all days; wherein a user can assign more than one recording schedule to a day.

23. The platform of claim 1, further comprising:
means within or associated with said system for assigning user rights and add, edit, delete, or modify permissions on a group-by-group basis.
